(19) United States
(12) Patent Application Publication
(10) Pub. No.: US 2026/0311706 A1
(43) Pub. Date: Oct. 8, 2026

(54) METHOD FOR PERFORMING PACKET LOSS CONCEALMENT IN COMPLEX FILTER BANK DOMAIN

(71) Applicant: DOLBY INTERNATIONAL AB, Dublin (IE)

(72) Inventor: Stefan Bruhn, Sollentuna (SE)

(73) Assignee: DOLBY INTERNATIONAL AB, Dublin (IE)

(21) Appl. No.: 19/471,821

(22) PCT Filed: Mar. 22, 2024
(86) PCT No.: PCT/EP2024/057822

§ 371 Date: Oct. 2, 2025

Related U.S. Application Data
(60) Provisional application No. 63/457,320, filed on Apr. 5, 2023.
(60) Provisional application No. 63/573,358, filed on Apr. 2, 2024.

(51) Int. Cl. G10L 19/005

(52) U.S. Cl. CPC G10L 19/005

(57) ABSTRACT

The present disclosure relates to a method and system for concealing a lost or corrupt frame of audio content in a sequence of audio frames The method comprises obtaining at least one first frame associated with the frame sequence and identifying whether a second frame, subsequent to the at least one first frame, is valid or invalid. When the second frame is identified as invalid, the method comprises generating a set of Time-Frequency (TF) tile values for a replacement frame to replace the second frame by applying a sinusoidal extension process to generate the set of TF tile values for the replacement frame or applying a linear prediction process to generate the set of TF tile values for the replacement frame based on a degree of tonality of at least one preceding frame.

### TECHNICAL FIELD

The present disclosure generally relates to systems, devices, and methods for processing audio.

### BACKGROUND

Unless otherwise indicated herein, the approaches described in this section are not prior art to the claims in this application and are not admitted to be prior art by inclusion in this section.

There exist many types of codecs for encoding audio content into a format that is suitable for inclusion in a bitstream. For example, there are several codecs that operate in the frequency domain, whereby segments of time-domain audio signals are transformed into vector-valued samples, each sample being represented in the encoded bitstream by a set of time-frequency, TF tiles combined with some side information. Each TF tile is associated with a specific frequency band and at the decoding end the samples carrying TF tiles are reconstructed by decoding the bitstream after which the time-domain samples are regenerated by applying an inverse transformation on the TF tiles.

There are many flavors of time-frequency transformations (and corresponding inverse transformations). Examples include the Discrete Fourier Transform (DFT), the Discrete

Cosine Transform DCT, the Modified Discrete Cosine Transform (MDCT) or Sub-band techniques that represent the original time-domain signal by samples in a sub-band domain. An example of a sub-band domain transformation is using Quadrature Mirror Filter (QMF) banks that have the property that each bandpass (or sub-band) signal may be critically sampled so as to still allow an inverse operation with perfect reconstruction of the original time signal.

A class of QMF based transformations operates in a complex valued domain in which case the time-domain signal, after transformation into the complex valued domain, is said to be represented in CQMF domain. In some cases, the CQMF bank is designed to introduce a minimum delay in the forward direction (CQMF analysis) as well as in the backward direction (CQMF synthesis), which makes CQMF banks especially useful in conversational speech applications and applications benefiting from low latency, such as telephony or teleconferencing applications.

A particular type of CQMF bank is used in the codec standardized for the 3GPP Immersive Voice and Audio Services (IVAS) codec. This CQMF bank is called the Complex Low-Delay Filter Bank (CLDFB) and, according to the CLDFB design, when CLDFB analysis is applied to a 48 kHz sampled audio signal, one TF tile (represented with one TF tile value) represents a frequency band of 400 Hz bandwidth and the CLDFB samples cover a time slot of 1.25 ms.

Services like 3GPP IVAS are often deployed over error-prone radio channels between a transmitting device and a receiving unit. In practice, the TF tiles of multiple CQMF samples are called frames which are encoded as a block of data, wherein each frame contains CQMF samples representing a predetermined duration of audio content (e.g. 20 ms). Coded frames are sent in a packetized batch of one or multiple coded frames, transmitted over the radio channel. However, there is a risk that one or more frames are corrupted, or not delivered to the receiving unit at all, resulting in what is referred to as a ‘packet loss’.

Some error-detecting mechanisms (such as cyclic redundancy check, CRC) may be applied in the receiving unit to detect if a packet (carrying one or more frames) has been received without errors or if the packet is corrupt. In some cases, a packet can also arrive too late to be used by the receiving unit. In any case, only the audio frames contained in packets received in time and without error can be used for audio decoding and extraction of the time audio signal.

For the frames unavailable for decoding, the receiving unit may use techniques to generate substitution frames. One technique for forming a substitution frame is to use a zero frame (i.e. a frame with each spectral coefficient equal to zero) as substitution signal. Another technique is to repeat the most recent frame that was received without error.

The art of generating substitution frames is called frame loss concealment or packet loss concealment (PLC). A general objective of these techniques is that frame losses should become as inaudible as possible so that their impact on the audio quality at the receiver is minimized. In cases relying on waveform coding, the packet loss concealment may be based on the frame repetition technique and in cases that rely on parametric coding, coding parameters of the most recent good frame are repeated.

Additionally, various PLC techniques are known from, for example, the 3GPP codec for Enhanced Voice Services (EVS). This codec contains a multitude of PLC techniques that may be selected depending on whether speech coding technology (ACELP) is used for coding of the signal or if audio coding technology (transform coding) is used.

It is with respect to these and other considerations that the disclosure made herein is presented.

### BRIEF SUMMARY OF THE DISCLOSURE

Techniques are described for processing audio signals. Various embodiments described herein provide for devices, systems and methods to mitigate the effects of lost frames that may occur in the transmission of audio signals. Various examples are described that improve concealment of lost frames by processing audio in a Complex Quadrature Mirror Filter (CQMF) domain.

A drawback with existing concealment techniques (e.g. PLC) is that they offer less than desired quality, often introducing perceptible audio artifacts. Additionally, many of the techniques are computationally complex (e.g. in terms of computational time, memory requirements and number of computational operations), requiring powerful processing hardware and/or increasing the latency of the audio encoding-decoding chain. At the same time, audio decoding is frequently performed on very power-limited end-devices such as earbuds or AR-glasses meaning that many concealment techniques are directly unsuitable for achieving low-latency and high quality concealment in some applications. To this end, the present disclosure identifies an improved concealment technique that can recreate high quality substitution frames with reduced complexity operations.

According to a first aspect of the present invention, there is provided a method to conceal a lost or corrupt frame with audio content in a frame sequence. The method comprises obtaining at least one first frame associated with the frame sequence, the at least one first frame being a frame of the frame sequence or a generated replacement frame and identifying whether a second frame, subsequent to the at least one first frame, is valid or invalid. When the second frame is identified as invalid, the method comprises generating a set of Time-Frequency (TF) tile values for a replacement frame to replace the second frame by analyzing the at least one first frame to determine a degree of tonality and comparing the degree of tonality to a threshold value to determine if the degree of tonality exceeds the threshold value. Wherein when the degree of tonality exceeds the threshold value, the method comprises applying a sinusoidal extension process to generate the set of TF tile values for the replacement frame and when the degree of tonality does not exceed the threshold value, the method comprises applying a linear prediction process to generate the set of TF tile values for the replacement frame. The method further comprises outputting the replacement frame to replace the second frame.

A frame that has been successfully received in full, and thus determined to be uncorrupted, at a time of decoding is identified as a valid frame. A frame that is determined to be corrupt or has not been received or is otherwise unavailable at a time of decoding (e.g., lost), is identified as an invalid frame. For at least the invalid frames, measures are taken to generate a replacement frame so as to conceal the invalid frame(s).

For the purposes of generating the set of TF tiles values for the replacement frame, the preceding first frame may be a valid frame, or a replacement frame for a preceding frame previously determined to be an invalid frame.

With the method of the first aspect, TF tile values for a replacement frame are generated adaptively by adaptively selecting one of two processes for generating the TF tile values of the replacement frame. The selection of which out of the two processes, sinusoidal extension and linear prediction, that is to be used is based on the degree of tonality of a preceding (first) frame. Since sinusoidal extension is expected to generate more accurate TF tile values when the degree of tonality is higher sinusoidal extension is used when the degree of tonality exceeds the threshold and since linear prediction is expected to generate more accurate TF tile values when the degree of tonality is lower linear prediction is used when the degree of tonality is below the threshold. In this way, TF tile values which make for a more realistic and believable replacement frame (serving as a continuation of the preceding first frame) can be generated which makes for a higher quality PLC technique.

There are various methods for quantifying the quality of a PLC technique. For example, subjective listening tests may be performed where listeners score the quality of audio signals which have been generated through a simulation of an error-prone transmission system resulting in frame losses and where the PLC technique to be tested is used to conceal the perceptual effect of the frame losses. The test subjects may be asked to score the perceived clarity or quality of the audio. Using these tests, different PLC techniques can be compared on the basis of their scoring. As an example, signal discontinuities that emerge when an invalid frame is replaced with a generated replacement frame are known to cause perceptual artifacts, whereby the quality of a PLC technique may be coarsely quantified by analysis of the smoothness of the audio signal at the transition between a valid frame and a generated replacement frame replacing an invalid frame.

According to a second aspect of the present invention, there is provided a method to conceal a lost or corrupt frame in Complex Quadrature Mirror Filter, CQMF, domain. The method comprising receiving at least one first frame of CQMF samples, wherein each CQMF sample spans one or more time-frequency (TF) tiles, and wherein each TF tile is associated with a frequency band and a complex TF tile value, respectively. The method further comprises identifying whether a second frame of CQMF samples, subsequent to the at least one first frame, is valid or invalid and when the second frame is identified as invalid, the method comprises for at least one of the respective frequency bands of the one or more TF tiles of the CQMF samples of the at least one first frame determining a complex parameter based on at least two of the TF tile values in the at least one first frame and generating a replacement TF tile value by modifying at least one TF tile value of the first frame with the complex parameter. The method further comprises and forming a replacement frame for the second frame based on the replacement TF tile value and outputting the replacement frame.

In the CQMF domain, the PLC techniques of this disclosure may be made highly computationally efficient. The complex parameter, which is based on at least two TF tile values of at least one preceding frame, may be used to generate a set of TF tile values for a replacement frame. In some implementations, the same complex parameter is used iteratively to generate two or more (or all) TF tile values of the replacement frame.

According to a third aspect of the present invention, there is provided an apparatus comprising a processor and memory, the apparatus being configured to perform the method of the first or second aspect.

According to a fourth aspect of the present invention, there is provided a non-transitory media having software stored thereon, the software including instructions for controlling one or more devices to perform the method of any of the first or second aspect.

According to a fifth aspect of the present invention, there is provided a computer program product comprising instructions which, when the program is executed by a computer, cause the computer to carry out the method of any of the first or second aspect.

According to a sixth aspect of the present invention there is provided a receiving unit comprising a decoder configured to receive a bitstream. The bitstream comprising data packets wherein each data packet carries a frame comprising a plurality of Time-Frequency, TF, tile values, wherein the decoder is configured to decode the received data packets of the bitstream to obtain the TF tile values of a current frame of a current data packet. The receiving unit further comprises a frame replacement module configured to identify if a current frame is invalid and, in response to identifying that the current frame is invalid, generate a set of TF tile values of a replacement frame for replacing the current invalid frame. The frame replacement module comprises a tonality extractor configured to analyze at least one preceding frame, the at least preceding frame preceding the current frame, to determine a degree of tonality of the preceding frame, and an adaptive sinusoidal extension and linear prediction module configured to determine if the degree of tonality exceeds the threshold value and when the degree of tonality exceeds the threshold value, generate the set of TF tile values for the replacement frame with a sinusoidal extension process, and when the degree of tonality does not exceed the threshold value, generate the set of TF tile values for the replacement frame with a linear prediction process. The receiving unit further comprises a synthesis filter bank configured to receive the TF tile values of the replacement frame and convert the TF tile values of the replacement frame to a time domain audio segment.

The embodiments described herein may be generally described as techniques, where the term “technique” may refer to system(s), device(s), method(s), computer-readable instruction(s), module(s), component(s), hardware logic, and/or operation(s) as suggested by the context as applied herein.

Features and technical benefits other than those explicitly described above will be apparent from a reading of the following Detailed Description and a review of the associate drawings. This Summary is provided to introduce a selection of techniques in a simplified form, and not intended to identify key or essential features of the claimed subject matter, which are defined by the appended claims.

The present invention according to the third, fourth, fifth and sixth aspect features the same or equivalent benefits as the present invention according to the first or second aspect. Any functions described in relation to a method, may have corresponding features in an apparatus or a computer program product.

### BRIEF DESCRIPTION OF THE DRAWINGS

The present invention will be described in more detail with reference to the appended drawings.

FIG. 1a is a block diagram illustrating an encoder and a decoder with a frame replacement module.

FIG. 1b is a block diagram illustrating a frame replacement module with adaptive selection of sinusoidal extension and linear prediction.

FIG. 2 is a diagram illustrating a frame comprising a plurality of samples.

FIG. 3 is a diagram illustrating a frame sequence wherein one frame is invalid and replaced with a generated replacement frame.

FIG. 4 is a flowchart illustrating processing in a frame replacement module according to some implementations.

FIG. 5 is a diagram illustrating a sinusoidal extension process.

FIG. 6a-d are diagrams illustrating a linear prediction process.

FIG. 7 is a diagram illustrating a linear prediction process using weighted combination with a substitute frame.

FIG. 8 is a diagram illustrating a crossfade from a generated replacement frame to a subsequent valid frame.

FIG. 9 illustrates a schematic block diagram of an example device or architecture that may be used to implement embodiments of the invention.

### DETAILED DESCRIPTION

In the following description, numerous details are set forth, such as systems, device configurations, timings, operations, and the like, in order to provide an understanding of one or more aspects of the present disclosure. It will be readily apparent to one skilled in the art that these specific details are merely examples and not intended to limit the scope of this application.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive- or is intended, such will be specifically noted (e.g., “either A or B”, “at most one of A and B”).

The term “includes” and its variants are to be read as open-ended terms that mean “includes, but is not limited to.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting, or deriving. In addition, in the following description and claims, unless defined otherwise, all technical and scientific terms used herein have the same meaning as commonly understood by one of ordinary skills in the art to which this disclosure belongs.

This document describes various processing functions that are associated with structures such as blocks, elements, components, circuits, etc. In general, these structures may be implemented by one or more processors that are controlled by one or more computer programs.

Various Acronyms may appear throughout this disclosure and in the associated claims and/or drawings are listed below. Other commonly used acronyms and terms of art may be excluded from this list in the interest of brevity. Thus, a short list of acronyms is provided below as an easy reference for the reader.
IVAS—Immersive Voice and Audio Services
PLC—Packet Loss Concealment
CRC—Cyclic Redundancy Check
QMF—Quadrature Mirror Filter
CQMF—Complex Quadrature Mirror Filter
CLDFB—Complex Low Delay Filter Bank
ACELP—Algebraic code-excited linear prediction
3GPP—3rd Generation Partnership Project
EVS—Enhanced Voice Services
IP—Internet Protocol
UDP—User Datagram Protocol
RTP—Real-time Transport Protocol
BFI—Bad Frame Indicator

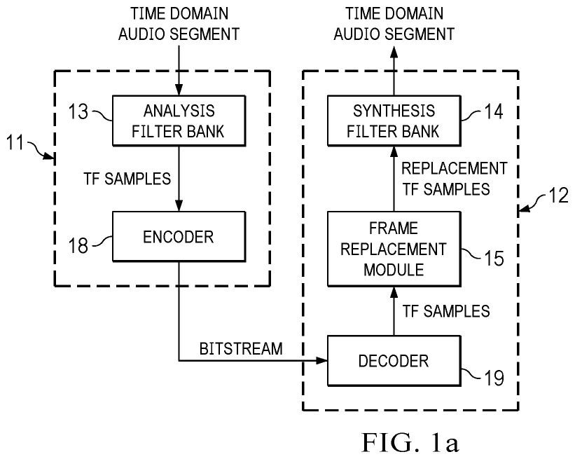

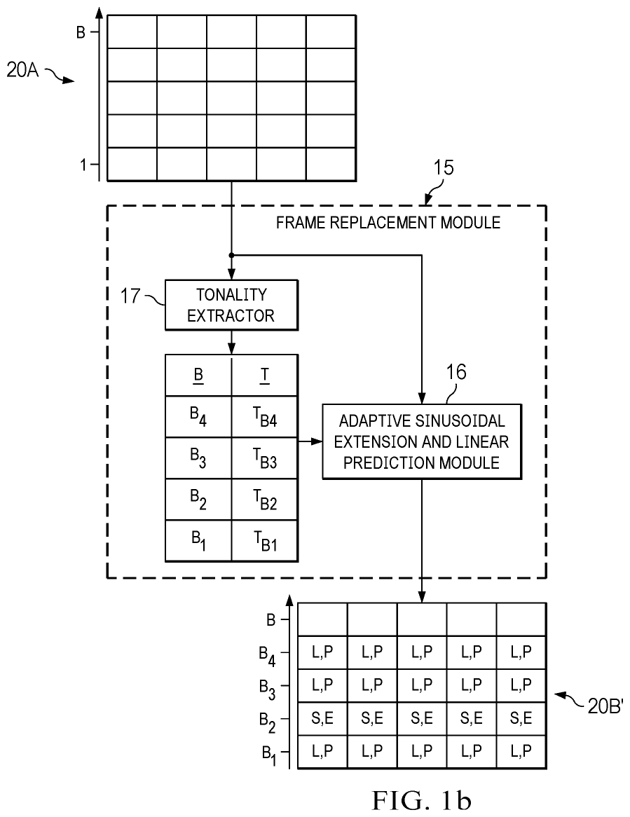

FIG. 1a shows schematically a sending unit 11 and a receiving unit 12. The sending unit 11 comprises an analysis filter bank 13 and an encoder 18. The receiving unit 12 comprises a decoder 19, a frame replacement module 15, and a synthesis filter bank 14.

In the sending unit 11, the analysis filter bank 13 is configured to obtain time domain audio segments of an audio signal and responsively convert the time domain audio segments into a Time-Frequency, TF, representation. The time domain audio segments comprise time domain samples of an audio signal and the analysis filter bank 13 converts the time domain audio samples into TF samples. Each TF sample may represent a plurality of time domain samples. Each TF sample may in turn comprise a plurality of TF tiles, with each TF tile representing a respective frequency band. The encoder 18 is configured to receive the TF samples of the TF representation and responsively encode the TF samples into a bitstream, which may be output for use by a receiving unit 12. The encoder 18 may form the bitstream by collecting a predetermined number of subsequent TF samples so as to form a frame of TF samples whereby the frames are coded into data packets that constitute the bitstream.

In the receiving unit 12, the decoder 19 is configured to receive the data packets of the bitstream and responsively decode the data packets of the bitstream to retain the frames of TF samples. The frame replacement module 15 is configured to receive the frames of TF samples from the decoder 19 and, in the case of a frame of TF samples being invalid, the frame replacement module 15 generates a replacement frame of TF samples. The synthesis filter bank 14 is configured to receive the frames of TF samples (or replacement frames thereof) and for each TF sample generate time domain samples of the time domain audio segments. The synthesis filter bank 14 in the receiving unit 12 is configured to perform an inverse filtering operation relative to the analysis filter bank 13 of the sending unit 11.

As an overview, an encoding and decoding process employed by the system of FIG. 1a may be described as follows. Time-domain audio segments that are received by the sending unit 11 are processed by the analysis filter bank 13 to obtain TF samples in the TF domain. The TF samples are grouped into frames which are encoded into a bitstream by encoder 18 and subsequently output (e.g., stored, transmitted, conveyed, etc.). The bitstream is received by the receiving unit 12 and processed by the decoder 19 to obtain the frames of TF samples. The frames of TF samples are processed by the frame replacement module 15 to generate a replacement frame with TF samples, when needed. The replacement frame of TF samples is processed by the synthesis filter bank 14 to generate time domain samples of recovered time domain audio segments. As will be described further below, the function of the frame replacement module 15 is to ensure that the adverse effects of frames with TF samples which are not received, corrupt or otherwise unavailable are mitigated by generating a replacement frame to replace frames which are not received, corrupt or otherwise unavailable.

In some implementations, the analysis filter bank 13 is a Quadrature Mirror Filter, QMF, bank whereby the TF samples are QMF samples in a QMF domain.

In some other implementations, the analysis filter bank 13 is a Complex Quadrature Mirror Filter, CQMF, bank such as the Complex Low-Delay Filter Bank, CLDFB, as specified in the 3GPP Immersive Voice and Audio Services, IVAS, codec. In such implementations, the TF samples are CQMF samples in a CQMF domain (such as the CLDFB domain).

The analysis filter bank 13 processes a received audio segment in the time domain. The time-domain audio segment consists of time-domain audio samples. The audio samples in the time domain are converted into a TF representation that is in a time-frequency domain, for example, by a Fourier Transform method as previously described above. The TF representation is then used in the output or transmitted in a bitstream that include TF representation samples. For example, each TF representation sample in the bitstream may correspond to a QMF or CQMF sample as will be described in more detail below.

Each analysis filter bank 13 is made up of multiple filters, where each filter has a passband defined over a specific range of frequencies. For example, a simple analysis filter bank with three filters may include a low-pass filter with a passband for frequencies below a first frequency (f₁), a band pass-filter with a passband for frequencies between the first frequency (f₁) and a second frequency (f₂), and a high-pass filter with a passband for frequencies above the second frequency (f₂). Each TF sample comprises one or more TF tiles wherein each TF tile may a correspond to a specific range of frequencies, such that each TF tile may map into a corresponding band of frequencies for a specific filter in the analysis filter bank 13. When a filter of the analysis filter bank 13 is applied to the time domain audio segment the time domain samples of the audio segment are multiplied by the filter characteristics (e.g., filter coefficients of the pass band or stop band, or interpolations thereof) to result in an output value for each time domain sample. The output values may subsequently be decimated. The optionally decimated output values form TF tile values that each occupy a TF tile of a TF sample.

When a QMF bank is used as the analysis filter bank 13, the output from the analysis filter bank 13 is in the form of QMF samples wherein each QMF sample represents a portion of audio content, and wherein each QMF sample may include multiple TF tiles, each representing a respective frequency band. Thus, a QMF sample can include multiple TF tiles, where each TF tile maps to a specific range of frequencies as described above. The number of TF tiles in a QMF sample corresponds to the number of filters in the analysis filter bank 13. Therefore, when a time domain audio segment is processed with the analysis filter bank 12, each filter in the analysis filter bank 12 outputs a corresponding stream of TF tile values associated with the frequency band of the particular filter.

That is, each QMF sample corresponds to a time slot of the time domain audio segment, and each of the one or more TF tile values of the same QMF sample (e.g. same time slot) represents a frequency band of that time slot in the time domain audio segment.

The specific passbands of the filters in the analysis filter bank 13 may be non-overlapping or partially overlapping. For example, each QMF filter may be defined as a bandpass filter with a passband that is centered about a unique center frequency. A first example bandpass filter may include two frequencies (f₁, f₂) defining a first bandwidth BW₁ of a first passband, while an adjacent second bandpass filter may include two frequencies (f₃, f₄) defining a second bandwidth BW₂ of a second passband. When the example passband frequencies are defined such that f₁<f₂<f₃<f₄ then the first and second passbands do not overlap. However, when the example passband frequencies are defined such that f₁<f₃<f₂<f₄ then portions of the first and second passbands overlap.

The analysis filter bank 13 may alternatively comprise a CQMF bank. Each filter of a CQMF bank outputs a stream of complex valued TF tile values, where the complex valued TF tile values are temporally grouped together to form CQMF samples. As a further example, if the analysis filter bank 13 is the CLDFB of the 3GPP IVAS codec, each filter has a passband of 400 Hz, is substantially non-overlapping and outputs complex TF tile values.

Since each filter in the analysis filter bank 13 is comparatively narrowband (e.g. when compared to full-band audio representations such as when sampled at 48 kHz) it is generally understood that analysis filter banks 13 comprises a large number of filters, such as ten or more filters, or one hundred or more filters. For example, when the CLDFB is used as the analysis filter bank 13, there can be 60 filters, each with a 400 Hz non-overlapping passband which is used to transform a time domain segment into CLDFB samples, each CLDFB sample containing 60 complex TF tile values.

The QMF (e.g. CQMF) samples output by the analysis filter bank 13 may be encoded by the encoder 18 and subsequently transmitted (e.g. wirelessly), stored or otherwise conveyed to the receiving unit 12. As described above, the encoder 18 may group multiple QMF (e.g. CQMF) samples into a frame and encode each frame as a coded data packet.

The decoder 19 is configured to decode the bitstream by decoding the coded data packet to obtain a frame of QMF samples. The QMF samples of frames of decoded data packets are provided to synthesis filter bank 14 which reconstructs samples of the time domain audio segments. The synthesis filter bank 14 in the receiving unit 12 is configured to perform an inverse filtering operation relative to the analysis filter bank 13 of the sending unit 11.

A sequence of coded data packets (each packet carrying a frame of QMF samples) are thereby delivered to the receiving unit 12 via the bitstream, wherein the decoder 19 performs a decoding operation to obtain the QMF samples of the coded data packets. In general, the coding of the QMF samples may be a lossy operation (e.g. due to quantization errors), wherein the QMF samples obtained after decoding may be an approximation of the QMF samples that were encoded.

If the receiving unit 12 successfully receives all data packets (i.e. all frames) associated with a time domain audio segment, all information for the synthesis filter bank 14 to recreate (at least an approximation of) the time domain audio segment is available, allowing the receiving unit 12 to regenerate (at least an approximation of) the time domain audio segment. However, when one or more data packets associated with a time domain audio signal are not received by the receiving unit 12, or when one or more data packets that are received and are determined to be corrupt, the receiving unit 12 will not have access to all frames to fully reconstruct the corresponding time domain audio segment. To this end, the frame replacement module 15 is employed to generate a set of TF tile values for a replacement frame, which replaces the one or more frames of the non-received or corrupt data packet(s).

In FIG. 1a, the frame replacement module 15 is depicted as a module which is separate from the decoder 19. However this is merely an example and the frame replacement module 15 may be an integral part of the decoder 19. In general, the decoder 19 and the frame replacement module 15 will be implemented as hardware, firmware or software in a client device or server acting as the receiving unit 12.

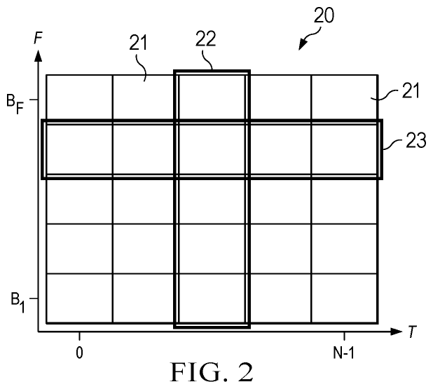

FIG. 2 shows schematically a frame 20 of QMF (e.g. CQMF) samples. The frame 20 comprises a plurality of TF tiles 21 which are grouped into a plurality of QMF samples 22 with time index n=0, . . . , N−1. Each QMF sample 22 comprises a number F of TF tiles 21 wherein each TF tile 21 of a QMF sample is associated with a respective frequency band Bᵢ, wherein index i=1, 2, . . . , F.

In the illustration of FIG. 2 an individual frequency band Bᵢ is represented by a row 23 wherein all TF tiles 21 of the same row contains a TF tile values associated with the same frequency band and the same corresponding QMF in the QMF bank used to extract the TF tile values.

The frame replacement module is configured to operate using frames 20 like the one depicted in FIG. 2. For example, the frame replacement module is configured to generate TF tile values for populating all the TF tiles 21 of a replacement frame (given one more preceding frames) for replacing a frame which has been lost or is otherwise unavailable.

The illustrative frame 20 of FIG. 2 comprises five frequency bands, i.e. F=5, and five QMF samples 22, i.e. N=5, which results in a total of 25 TF tiles 21. The frame 20 shown in FIG. 2 is merely an example and it is understood that the frame size may be determined almost arbitrarily depending on the implementation. For example, the Complex Low-Delay Filter Bank (CLDFB) used in the 3GPP IVAS codec uses 60 filters, each with a bandwidth of 400 Hz and each sample 22 representing 1.25 ms. A frame size typically used represents 10-20 ms of audio content, or about 8-16 CLDFB samples, for a total of between 8*60=480 TF tiles 21 and 16*60=960 TF tiles 21 in a frame 20. The CLDFB may be applied to a 48 kHz sampled audio signal whereby 60 filters of 400 Hz bandwidth capture the lower 24 kHz of the 48 kHz sampled audio signal. However, since the frequency spectrum of a 48 kHz audio signal is symmetric around half of the sampling frequency (24 kHz, also referred to as the folding frequency) the frequency spectrum above 24 kHz may be reconstructed after decoding by mirroring the frequency spectrum of the lower frequencies around the 24 kHz.

FIG. 1b shows schematically a frame replacement module 15 arranged according to some implementations. The frame replacement module 15 comprises a tonality extractor 17 and an adaptive sinusoidal extension and linear prediction module 16.

The frame replacement module 15 is configured to generate TF tile values for a replacement frame 20B′ given at least one preceding frame 20A which may be referred to as the first frame 20A. The frame replacement module 15 comprises an adaptive sinusoidal extension and linear prediction module 16 which generates the TF tile values for the replacement frame using 20B′ using either a sinusoidal extension process or a linear prediction process. The frame replacement module 15 further comprises a tonality extractor 17 configured to extract, for each frequency band of the preceding first frame 20A, a degree of tonality. The degree of tonality is provided to the adaptive sinusoidal extension and linear prediction module 16, which generates the TF tile values for the replacement frame using 20B′ using either a sinusoidal extension process or a linear prediction process, wherein the type of process employed is based on the degree of tonality of each frequency band.

In FIG. 1b the preceding first frame 20A of QMF samples is input to the frame replacement module 15. The first frame 20A is provided to the tonality extractor 17 which extracts, for each frequency band Bᵢ, a degree of tonality Tᵢ. For example, the tonality extractor 17 extracts individual degree of tonality values T₁, T₂, T₃, T₄ for each of frequency bands B₁, B₂, B₃, B₄. The degree of tonality Tᵢ for each frequency band Bᵢ in the first frame 20A is provided to the adaptive sinusoidal extension and linear prediction module 16 alongside the first frame 20A. The adaptive sinusoidal extension and linear prediction module 16 determines whether to use a sinusoidal extension process or a linear prediction process for each frequency band Bᵢ based on the band-specific degree of tonality Tᵢ. Using the sinusoidal extension process or the linear prediction process the adaptive sinusoidal extension and linear prediction module 16 generates TF tile values of the replacement frame 20B′ and outputs the replacement frame 20B′ with the generated TF tile values of bands Bᵢ with the selected type of processing.

As an overview, the frame replacement module 15 is according to some implementations configured to analyze at least one preceding first frame 20A and generate a set TF tile values that can be used to form a replacement frame 20B′ that replaces a subsequent second frame. The frame replacement module 15 may comprise an adaptive sinusoidal extension and linear prediction module 16 which generates the set of TF tile values using either a sinusoidal extension process or a linear prediction process. The type of process employed may be selected individually for each frequency band based on a degree of tonality of each frequency band of the first frame as determined by the tonality extractor 17 of the frame replacement module 15. Hereby, the TF tile values of one or more frequency bands in the replacement frame 20B′ may be generated using sinusoidal extension and the TF tile values of one or more other frequency bands may be generated using linear prediction based on the degree of tonality of each individual frequency band.

The frame replacement module 15 may further be configured to store one or more of the preceding first frames 20A so as to be able to access the TF tile values of these frames when a replacement frame 20B for a current second frame is to be generated.

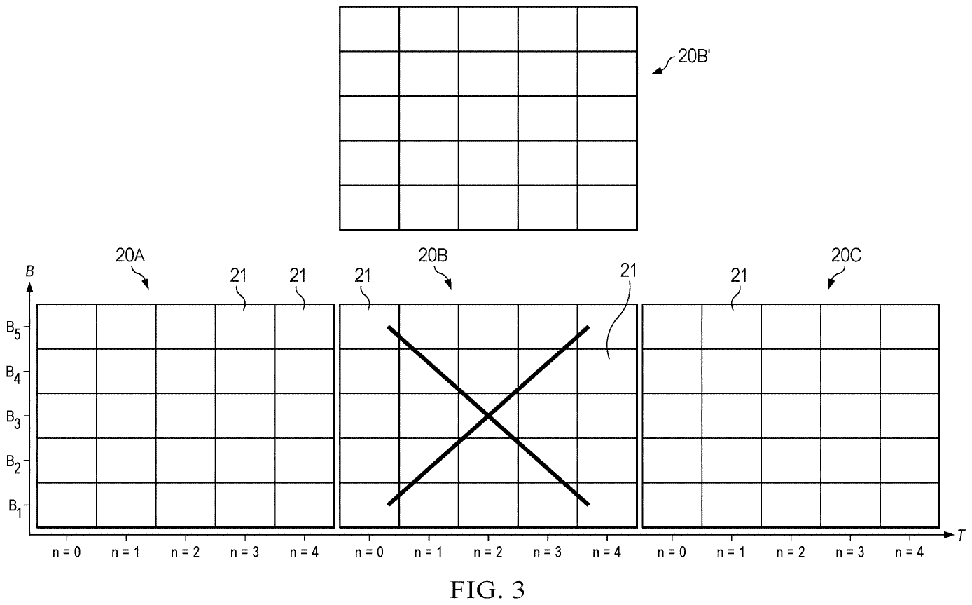

FIG. 3 shows schematically a frame sequence of three frames 20A, 20B, 20C. The frame sequence comprises a first frame 20A, a second frame 20B temporally subsequent to the first frame 20A and a third frame 20C, temporally subsequent to the second frame 20B. Each frame comprises a plurality of QMF samples (columns), wherein each QMF sample comprises a plurality of TF tiles, each TF tile associated with a respective frequency band Bᵢ (rows).

Each of the frames 20A, 20B, 20C of the frame sequence may be encoded by the encoder in the sending unit to a corresponding number of coded data packets (each data packet carrying one frame) wherein the data packets are transmitted to the receiving unit as a bitstream. However, one or more data packets may be lost or corrupted on its way to the receiving unit whereby the frame included in these lost or corrupted data packets will not be available for the receiving unit. In the frame sequence of FIG. 3 the second frame 20B may be a frame which is not available at the receiving unit (e.g. is lost or corrupted) and the purpose of the frame replacement module of the receiving unit is then to generate a replacement frame 20B′ based on information from the preceding frames, which can be used to replace the unavailable second frame 20B.

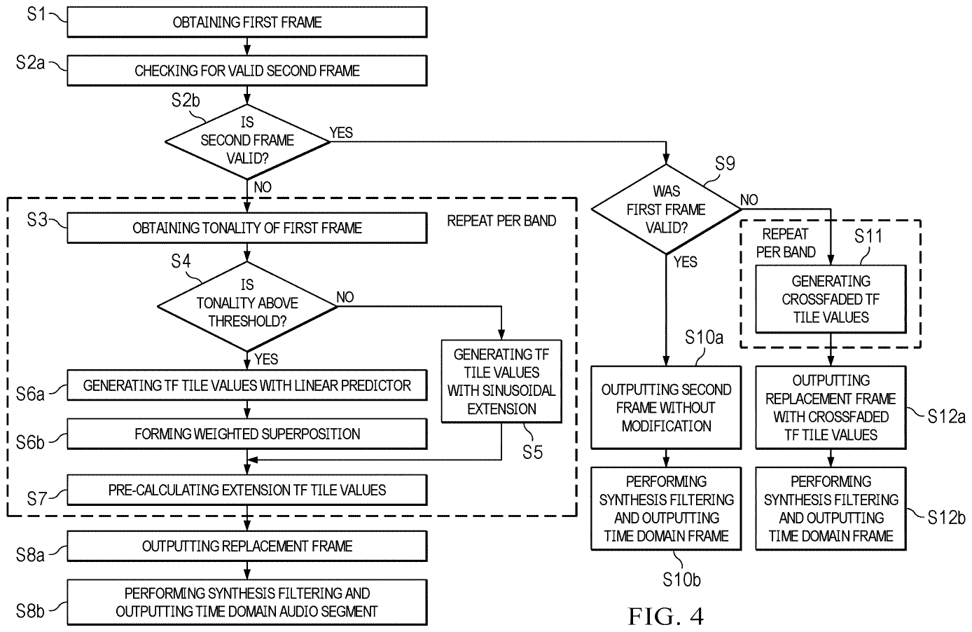

With reference to the flowchart of FIG. 4 and the frame sequence of FIG. 3, a method for forming a replacement frame will now be described. The method may be performed by the frame replacement module 15 described above.

At step S1, “obtaining a first frame”, a first frame 20A is obtained. For example, the first frame 20A is associated with a bitstream received by the frame replacement module and/or the decoder. The first frame 20A may either be a replacement frame (e.g., a frame which has been previously generated by the frame replacement module in response to an original first frame being lost or corrupt) or an original first frame which was delivered to the frame replacement module and/or decoder.

At step S2a, “Checking for valid second frame”, the decoder and/or the frame replacement module checks if a second frame 20B, subsequent to the first frame 20A, is available and is not corrupt. A frame that is available for decoding and not corrupted is identified as a valid frame. If a frame is not available, is corrupted or otherwise unavailable, then the frame is identified as invalid.

The frames (and/or the data packets carrying the frames) may be intended to arrive at the receiving unit as a consecutive sequence. However, if a frame (or data packet) is lost, delayed or arrives corrupted (i.e. is invalid) at the time the frame should be processed by the receiving unit (e.g. to maintain audio playback without interruption) this should be identified to allow a replacement frame to be generated. Therefore, at step S2a the receiving unit checks if a valid second frame is available so as to e.g. allow sufficient time to generate a replacement frame.

At step S2b, “Is second frame valid?”, the result from step S2a is used to identify if the second frame 20B is available or if it has been lost, is corrupt or otherwise unavailable. This identification is referred to as identifying whether the second frame 20B is a valid frame or an invalid frame. Accordingly, if the second frame 20B is not available at step S2a, or the second frame 20B is determined at step S2a to be corrupt, then the method determines at step S2b that the second frame is invalid. On the other hand, if the second frame 20B is available at step S2a and the second frame is not corrupt, then the method determines at step S2b that the second frame 20B is valid.

The decoder (and/or analogously the frame replacement module) may operate frame-synchronously, meaning that the decoder decodes a frame each T seconds, wherein Tis a predetermined time interval. For example, T is equal to the temporal duration of one frame, such as 20 ms. In some implementations, the frames 20A, 20B are conveyed as data packets using one or more data transmission protocols to the receiving unit. Example data transmission protocols include IP, UDP and RTP. The decoder of the receiving unit collects the data packets and may store them in a buffer. The data packets may arrive asynchronously, and some data packets may not arrive at all. For example, one or more data packets may not arrive due to buffer overflows caused by data traffic congestion along the transmission path. Additionally, some packages may arrive with an error, which is detected by a CRC mechanism. A packet which arrives too late so that it is unavailable when the decoder requires it in order to operate frame-synchronously is one example of an invalid data packet and the frame associated with this data packet is an example of an invalid frame. A data packet which does not arrive at the receiving unit at all (e.g., a lost packet) is another example of an invalid data packet and the frame associated with this data packet is an example of an invalid frame. A data packet which arrives with an error detected by a CRC mechanism are is yet another example of an invalid data packet and the frame associated with this data packet is an example of an invalid frame.

For each instance where an invalid frame (e.g. each invalid packet) is identified, a Bad Frame Indicator (BFI) flag is raised. When the decoder is to decode a frame associated with a raised BFI flag, the part of the buffer that would normally contain the frame is disregarded and the packet loss concealment process is activated. Identifying if a frame is valid or invalid may therefore comprise identifying if a BFI flag has been raised for the frame, whereby the frame is identified as invalid if the BFI flag is raised and invalid if there is no raised BFI flag.

Accordingly, it is possible for the decoder and/or frame replacement module to identify that a frame is invalid even if the frame is not received. In frame-synchronous operation, it may be assumed that a frame should have reached the decoder and/or frame replacement module of the receiving unit within a predetermined time interval. The beginning of the predetermined time interval may be measured from the last successful receipt of a frame or data packet. Therefore, a frame may be labeled (identified) as invalid when it is determined that a frame or data packet is not available after the expiration of the predetermined time interval after (successfully) receiving the preceding frame or data packet.

When it is determined at step S2b that second frame 20B is invalid, a set of TF tile values for a replacement frame 20B′ are to be generated.

In some implementations, the type of processing used to generate the TF tile values is selected individually for each frequency band based on the degree of tonality of the corresponding frequency band of the at least one preceding frame. To this end, the generated replacement frame may comprise a mix of frequency bands containing TF tile values generated with sinusoidal extension and frequency bands containing TF tile values generated with linear prediction. Of course, the same general processing may be applied for frames having a single frequency band.

To generate the set of TF tile values for the replacement frame the method may proceed to step S3, “Obtaining tonality of first frame”, which comprises analyzing the first frame 20A to determine a degree of tonality for the first frame 20A. In some implementations, the degree of tonality is determined individually for each frequency band so as to yield one degree of tonality for each of a plurality of frequency bands, individually.

Determining the degree of tonality of a frame (e.g. the first frame 20A) may involve analyzing the TF tile values of the frame (e.g. in each frequency band individually). For example, the first frame 20A may be temporarily stored and accessible, wherein determining the degree of tonality comprises analyzing the TF tile values of the first frame 20A.

In some implementations, determining the degree of tonality of a frame (e.g. the first frame 20A) comprises evaluating TF tile values of the at least one first frame 20A to identify differences in (e.g. complex) phase between different TF tile values of the frame and calculating a phase standard deviation based on the identified differences in phase between different TF tile values of the frame. The phase standard deviation may be used as a degree of tonality wherein a lower phase standard deviation may be used as an indicator of a higher degree of tonality.

Alternatively, determining the degree of tonality of a frame (e.g. the first frame 20A) comprises evaluating TF tile values of the at least one first frame to identify magnitude ratios between different TF tile values and calculating a magnitude standard deviation based on the identified magnitude ratios between different TF tile values. The magnitude standard may be used as a degree of tonality wherein a lower magnitude standard deviation may be used as an indicator of higher degree of tonality.

As mentioned above a degree of tonality may be determined for each frequency band, individually. It is envisaged that the same method for determining the tonality may be used in each frequency band, or that different methods for determining the tonality may be used in different frequency bands. Non-limiting examples of different methods considered are described further below.

With further reference to FIG. 1b a replacement module 15 according to some implementations is depicted. The frame replacement module 15 comprises a tonality extractor 17 which analyzes the first frame 20A to determine the degree of tonality for each frequency band individually. The degree of tonality of individual frequency bands is denoted T_{Bi} and in the example shown in FIG. 1b the degree of tonality T_{B1}, T_{B2}, T_{B3}, T_{B4}, for four frequency bands are provided by the tonality extractor 17 to the adaptive sinusoidal extension and linear prediction module 16.

The method may then proceed to step S4, “Is tonality above threshold?”, which comprises determining, for each frequency band, if the degree of tonality T_{B1}, T_{B2}, T_{B3}, T_{B4}, exceeds a predetermined threshold. This step may be performed by the adaptive sinusoidal extension and linear prediction module 16. The predetermined threshold may be the same for each frequency band, or it is envisaged that different predetermined thresholds may be used.

In one example, the predetermined threshold is a phase threshold. By comparing the phase standard deviation of a specific frequency band to the phase threshold it is possible to determine if a specific frequency band is tonal. When the phase standard deviation is below the phase threshold, the specific frequency band is identified as tonal. When the phase standard deviation is equal to or greater than the phase threshold, the specific frequency band is determined as noise-like. The phase threshold for the standard deviation may be determined by calculation, experimentation, measurements, and other such techniques. In one example, the phase threshold for the standard deviation is about

$$\frac{π}{6} .$$

As another example, the predetermined threshold is a magnitude threshold. By comparing the magnitude standard deviation to the magnitude threshold it is possible to determine if a specific frequency band is tonal. When the magnitude standard deviation is below the magnitude threshold, the specific frequency band is identified as tonal. When the magnitude standard deviation of the specific frequency band is equal to or greater than the magnitude threshold, the specific frequency band is determined as noise-like. The magnitude threshold for the standard deviation may be determined by calculation, experimentation, measurements, and other such techniques. In one example, the magnitude threshold for the magnitude standard deviation is about 0.1.

For each frequency bands where the degree of tonality of the first frame 20A indicates that the TF tile values are tonal, the method may proceed to step S5, “Generating TF tile values with sinusoidal extension”, which comprises generating a set of TF tile values for the frequency band of a replacement frame using a sinusoidal extension process. As seen in the example of FIG. 1b, individual TF tile values of frequency band number B₂ in the replacement frame 20B′ have been reconstructed using sinusoidal extension (abbreviated S.E).

The sinusoidal extension process may further comprise calculating extension TF tile. Extension TF tile values of a frame (e.g. the first frame 20A) are TF tile values that are temporally later than QMF sample N−1 of that frame (e.g. the first frame 20A), as will be discussed below.

On the other hand, for frequency bands where the degree of tonality indicates that the TF tile values are those of a noise-like signal, the method proceeds to step S6a, “Generating TF tile values with linear predictor”, which comprises generating the TF tile values for a replacement frame using a linear prediction process. As seen in the example of FIG. 1b, individual TF tile values of frequency bands B1, B3 and B4 in the replacement frame 20B′ have been reconstructed using linear prediction (abbreviated L.P).

In this way, the adaptive sinusoidal extension and linear prediction module 16 generates TF tile values for frequency bands with a comparatively high degree of tonality with sinusoidal extension, and generates TF tile values for frequency bands with a comparatively low degree of tonality with linear prediction.

The linear prediction process may comprise calculating extension TF tile values with the linear prediction process based on at least two TF tile values in the first frame 20A.

Optionally, the method then proceeds to step S6b, “Forming weighted superposition”, which comprises, for each frequency band, forming a weighted superposition between the TF tile values generated with the linear prediction process and a substitute frame. The substitute frame may be a copy of the preceding first frame 20A. In some implementations, the weighted superposition is performed for a predetermined number of the temporally earliest TF tile values of the replacement frame, as will be described in further detail below.

It is understood that the frame structure of the replacement frame may be equal to that of the invalid second frame 20B. The sinusoidal extension process and the linear prediction process may be used to generate a subset (e.g. a proper or strict subset) of the TF tile values of the replacement frame or generate all TF tile values of the replacement frame. As mentioned above, it is further understood that the step of generating TF tile values with sinusoidal extension or linear prediction at step S5 and S6a is done for each frequency band, individually. This enables the TF tile values of one or more frequency bands to be generated with sinusoidal extension, while the TF tile values of one or more other frequency bands of the same frame may be generated with linear prediction, based on the degree of tonality calculated for each frequency band at step S3.

It is understood that generating a set of TF tile values for a replacement frame may be performed individually for each of a plurality of frequency bands when the frame comprises TF tile values spanning more than one frequency band. As described, the TF tile values are generated using either the sinusoidal extension process or the linear prediction process for each frequency band, individually.

After generating the set of TF tile values for the replacement frame with sinusoidal extension and/or linear prediction at step S5 and/or step S6a, S6b the method may proceed to optional step S7, “Pre-calculating extension TF tile values”, which comprises determining extension TF tile values using the selected TF tile value generation process. The extension tile values are tile values which are temporally later than the tile values of sample N−1 of the replacement frame. As will be described below, the TF tile value generation processes may in principle operate continuously, generating an arbitrary number of extension samples after generating a set of (or optionally all) TF tile values of the replacement frame. By generating the extension TF tile values at step S7, the extension TF tile values may be stored or otherwise made available for a third frame 20C, which is subsequent to the second frame 20B. The extension TF tile values are then used to form a perceptually high quality transition into the third frame 20C when the third frame 20C is a valid frame. If the third frame 20C is another invalid frame, the extension TF tile values may be retained or regenerated as a replacement frame for the third frame 20C is generated.

The method may then proceed to step S8a, “Outputting replacement frame”, which comprises outputting the replacement frame as a replacement for the second frame. The replacement frame outputted at step S8a is still in the QMF (e.g. the CQMF) domain. To convert the QMF (e.g., CQMF) frame to a time domain representation the method may go to step S8b, “Performing synthesis filtering and outputting time domain frame”, which may comprise processing the replacement frame with the synthesis filter to form a time domain audio frame which is outputted.

Turning back to step S2, when it is determined that the second frame 20B is a valid frame the method proceed to step S9, “Was first frame valid?”, which comprises determining if the first frame 20A was a valid frame or an invalid frame. Determining whether the first frame 20A was valid may comprise identifying if a BFI flag associated with the first frame 20A (or a data packet carrying the first frame 20A) was raised. For instance, for each frame 20A, 20B, 20C processed by the replacement module and/or decoder, the BFI flag value indicates if the frame was valid or invalid. The BFI flag may be temporally stored to allow identification of whether a preceding frame was valid or invalid.

If it is determined at step S9 that the preceding frame was valid, the method may proceed to step S10a, “Outputting second frame without modification”, which may comprise outputting the second frame without modification. That is, if both the first and second frame 20A, 20B are identified as valid frames, then it is not necessary to perform any frame replacement and all information is available to the decoder whereby the second frame 20B is output without modification. For example, if the frame replacement module and/or decoder obtains a sequence of only valid frames, then no frame replacement is needed and the frame replacement module outputs unmodified frames. Optionally, to convert the QMF frame to a time domain representation the method may proceed to step S10b, “Performing synthesis filtering and outputting time domain frame”, which may comprise processing the replacement frame with the synthesis filter to form a time domain audio frame which is outputted.

If it is determined at step S9 that the preceding frame is an invalid frame, then the method proceeds to step S11, “Generating crossfaded TF tile values”, which comprises obtaining an extension set of TF tile values of the first frame 20A and generating one or more crossfaded TF tile values for the second frame 20B. Generating the crossfaded TF tile values may comprise crossfading the extension TF tile values with the TF tile values of the second frame in a crossfade region. It is noted that at step S11 the first frame 20A is invalid (and has been replaced with a replacement frame), while the second frame 20B is valid. Hereby, a perceptually high quality transition from the replacement frame to the second frame 20B is to be achieved. Analogous to step S7, the extension set of TF tile values for the first frame 20A may be generated with the sinusoidal extension process or the linear predictor process, which may already be available since the extension TF tile values were generated when the first frame 20A was replaced with a replacement frame.

Step S11 may also be repeated for each frequency band, individually. It is envisaged that the extension TF tile value for one frequency band may be generated with sinusoidal extension, while the extension TF tile values for another frequency band may be generated with linear prediction, depending on the determined degree of tonality of the frequency bands of the preceding frames.

The crossfade region may comprise a predetermined number K of the temporally earliest samples of the second frame 20B.

In some implementations, the crossfading TF tile values are formed as a crossfade weighted sum of a TF tile value of the second frame 20B with a TF tile value of the extension set of TF tile values from the first frame 20A. The two summands of the crossfade weighted sum are weighted with a respective crossfade weighing factor. The crossfade weighting factor for the TF tile values of the second frame 20B is temporally increasing between subsequent QMF samples. The crossfade weighting factor for the TF tile values of the extension set of TF tile values is temporally decreasing between subsequent QMF samples in a complementary manner.

That is, the crossfading weighting factor may be inversely proportional to the sample index n. This results in each crossfaded TF tile value comprising a reduced number of the extension TF tile values and an increased number of the TF tile values of the second frame 20B as the sample index n increases. In some examples, the crossfade weighting factor may change linearly or non-linearly (e.g., exponentially) with the sample index to control the transition from generated TF tile values to the TF tile values of the second frame 20B.

The method may then proceed to step S12a, “Outputting replacement frame with crossfaded TF tile values”, which comprises outputting a replacement frame for replacing the second frame 20B wherein the replacement frame comprises the crossfaded TF tile values. The replacement frame may comprise the crossfaded TF tile values in the crossfading region, while in a trailing region, which is temporally later than the crossfading region, the replacement frame comprises the unmodified TF tiles values of the second frame 20B.

Optionally, to convert the replacement QMF frame to a time domain representation the method may proceed to step S12b, “Performing synthesis filtering and outputting time domain frame”, which comprises processing the replacement frame with the synthesis filter to form a time domain audio frame which is outputted.

The sinusoidal extension process and the linear prediction process for generating a set of TF tile values are applicable for any type of frame carrying at least two temporally subsequent QMF samples. That is, each frame comprises at least two temporally separated TF tile values. In some implementations, each frame comprises complex TF tile values. For example, each frame has been generated with a CQMF bank (such as the CLDFB).

It will now be assumed that the frames 20A, 20B, 20C of FIG. 3 are complex frames generated with a CQMF bank. The frames 20A, 20B, 20C carry TF tiles 21, wherein each TF tile comprises a complex TF tile value representing a frequency band and time duration of the time domain audio signal.

During normal operation, when none of frames 20A, 20B, 20C are identified as invalid (e.g. lost or corrupted) a stream of the frames 20A, 20B, 20C is available for decoding in the intended order. When a given frame is identified as invalid (e.g. has been lost or corrupted) there will in general be at least one frame preceding the given frame which has been received without error. However, the sinusoidal extension process and the linear prediction processes may operate recursively and generate TF tile values for replacement of an arbitrary number of invalid frames, as will be described below.

To describe the sinusoidal extension process and the linear prediction process it will, without loss of generality, be assumed that the second frame 20B is an invalid frame (for which a replacement frame is to be generated) and that the preceding first frame 20A is available or at least a replacement frame for the first frame 20A is available.

The third frame 20C, which is subsequent to the second frame 20B, may be identified as a valid frame or an invalid frame as will be discussed below.

The two TF tile value generation processes (i.e. the sinusoidal extension process and the linear prediction process) may be used separately. That is, implementations utilizing only sinusoidal extension or linear prediction are envisaged. Alternatively, the two processes may be used together in sequence and/or in parallel for different frequency bands. In some implementations, an adaptive frame replacement technique is used, where one of the sinusoidal extension process and the linear prediction process is used for each invalid frame, or for each frequency band of each invalid frame, based on the degree of tonality of a preceding frame (or a replacement frame thereof), or each frequency band of the preceding frame.

In the frame sequence of FIG. 3 the second frame 20B is an invalid frame and a set of TF tile values (e.g. all TF tile values of a replacement frame 20B′ having the same frame structure of the second frame 20B) are to be generated to form a replacement frame 20B′.

When operating in a CQMF domain both the sinusoidal extension process and the linear prediction process is performed by determining a complex parameter z based on at least two TF tile values of the first frame 20A. The TF tiles 21 in the first frame 20A whose TF tile values are used to determine the complex parameter z may be of the same frequency band Bₓ as the set of TF tile values that are to be generated. For example, when a complex TF tile value in the second frame 20B belonging to a TF tile 21 of frequency band Bₓ is to be generated the complex parameter z is determined from TF tile values of frequency band Bₓ in the first frame 20A.

The complex parameter z may describe a ratio between the two TF tile values of the first frame 20A. The complex parameter z may describe a difference between two parameters derived from the two TF tile values. For example, the complex parameter z describes the difference between the phase of two TF tile values. The complex parameter z allows generation of a TF tile value in the second frame 20B by extrapolating from a TF tile value of the first frame 11 using the complex parameter z. The TF tile value from which the extrapolation is made may be one of the TF tile values used to determine the complex parameter z or a different TF tile value. In some implementations, the TF tile value used for extrapolation is the temporally latest TF tile value of the first frame 20A.

The complex parameter z may be one or more of a phase parameter (e.g. e^{jΔφ} or Δφ), a magnitude parameter κ, and one or more complex predictor coefficients γᵢ as will be described below.

The sinusoidal extension process and the linear prediction process may also be performed (with some limitations) in the real valued QMF domain wherein the complex parameter z is replaced with a real valued parameter that describes e.g. a ratio between two TF tile values of the first frame 20A.

The sinusoidal extension and linear prediction process will now be described in detail. In this description it is assumed that each technique process in a specific frequency band Bₓ but it is understood that the processes may operate in an analogous manner in a plurality of frequency bands.

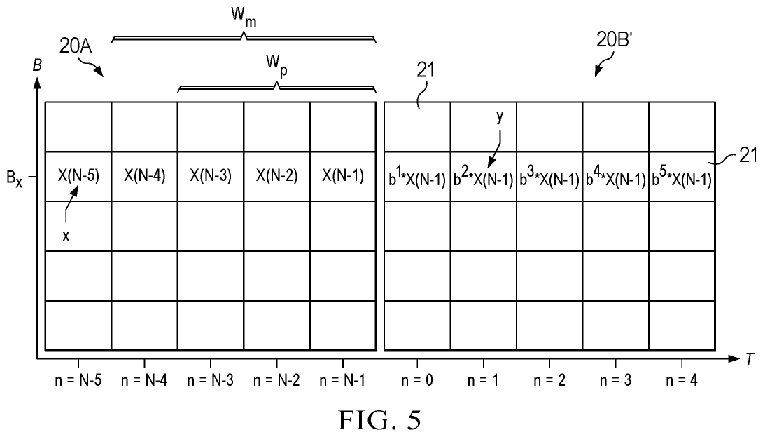

In FIG. 5 the sinusoidal extension process for generating TF tile values of a replacement frame 20B′ based on at least one first frame 20A is illustrated schematically. The sinusoidal extension process is performed by the frame replacement module to generate TF tile values of one or more frequency bands of a replacement frame.

The first frame 20A is a valid frame or a replacement frame for an invalid preceding first frame. The subsequent second frame is an invalid frame wherein the TF tile values of the replacement frame 20B′ for the second frame should be generated.

The first frame 20A features a plurality of frequency bands Bᵢ, comprising a specific frequency band Bₓ, and CQMF samples n ranging from 0 to N−1. The second frame and the replacement frame 20B′ have the same general structure as the first frame 20A. Since the second frame is invalid a set of TF tile values of a replacement frame 20B′ are to be generated.

The sinusoidal extension process assumes that for the specific frequency band Bₓ there is a sinusoidal signal component in the first frame 20A.

In the real valued QMF domain a sinusoidal signal component x(n) can be modelled as

$$x ( n ) = a sin ( 2 π n \frac{{f}_{0}}{{f}_{s}} + {ϕ}_{0} ) \qquad ( 1 )$$

wherein a is a magnitude parameter, f₀ is the frequency of the sinusoidal signal component, fₛ is the sampling frequency, φ₀ is a phase offset at the start of the first frame 20A and n denotes the QMF sample index. If the parameters a, f₀, fₛ and φ₀ of the sinusoidal signal component x in a QMF domain representation of the first frame 20A are determined, generation of a QMF domain representation of a replacement frame 20B′ may be performed based the assumption that the same sinusoidal signal component will continue also into the second frame. That is, the replacement frame 20B′ for the second frame can be generated under the assumption that the sinusoidal signal component x continues into the second frame (and therefore exists in the replacement frame 20B′). The extension of the sinusoidal signal component x into the replacement frame 20B′ for the frame is denoted y(n) where n in this context denotes the QMF sample index of the replacement frame 20B′ of the second frame.

Accordingly, the sinusoidal extension of a QMF domain representation of a frame into the replacement frame 20B′ may be determined as

y(n)=a sin((n+1)Δφ+φ₋₁) (1)

wherein φ₋₁ denotes the phase of the sinusoidal component in the last time domain sample N−1 of the first frame 20A and Δφ is a phase parameter describing the phase difference between subsequent time domain samples in the first frame 20A i.e. a by-sample phase evolution parameter. The by-sample phase evolution parameter may be expressed as:

$$Δ ϕ = 2 π \frac{{f}_{0}}{{f}_{s}} . \qquad ( 2 )$$

If the by-sample phase evolution Δφ is known, the sinusoidal phase φ₋₁ of the last time domain sample N−1 of the first frame 20A may be extracted from the phase offset at the start of the first frame 20A as

φ₋₁=(N−1)Δφ+φ₀. (3)

It is however challenging to reliably determine the parameters a, Δφ and φ₋₁ to generate a replacement frame. For example, real world signals are rarely pure sinusoids and often feature e.g. transients and noise.

Turning to the CQMF bank domain, each TF tile 21 comprises a complex TF tile value, and not a real number as is the case for real valued QMF bank domains or for time domain audio signals. To apply the sinusoidal extension technique in the CQMF domain it is assumed that a complex sinusoidal signal component in the first frame 20A can be described as

$$x ( n ) = {a}_{0} {e}^{j 2 π n \frac{{f}_{0}}{{f}_{s}}} \qquad ( 4 )$$

wherein a₀ is a complex valued start parameter equal to the TF tile value of the first CQMF sample n=0 in the first frame 20A. In general, it is understood that a complex sinusoidal signal component may be identified for each frequency band individually. Based on the further assumption that this complex sinusoidal signal component continues from the first frame 20A into the replacement frame 20B′, the extension of the complex sinusoidal signal component into the replacement frame 20B′ may be expressed as

y(n)=a₋₁e^{j(n+1)Δφ} (6)

wherein a₋₁ is a complex valued end parameter having a magnitude equal to the sinusoidal magnitude a of above and a phase which corresponds to φ₋₁ of above.

The complex sinusoidal signal component described in equation 6 has a by-sample phase evolution which can be described in its entirely by a single complex evolution parameter b The complex evolution parameter b can be expressed as

b=e^{jΔφ} (7)

and it is realized that, ideally, the phase evolution of a TF tile value from one CQMF sample y(n) to a subsequent CQMF sample y(n+1) follows the pattern arg[y(n+1)]=arg [e^{jΔφ}×y(n)] where the function arg [⋅] extracts the phase of the argument. Generally, the phase evolution from one CQMF sample to the next is assumed to be constant, meaning the phase of any TF tile value in a replacement frame 20B′ for the invalid second frame may be determined using the complex evolution parameter b. For example, it can be assumed that the phase of a TF tile value in CQMF sample n+k can be determined from the phase of a TF tile value at index n as arg[y(n+k)]=arg [e^{jΔφk}×y(n)] where k is any positive or negative integer.

The TF tile values y(n) of the replacement frame 20B′ for the second frame may be generated by multiplying the end parameter a₋₁ with b raised to the (n+1)-th power. That is, y(n) may be obtained as

y(n)=a₋₁bₙ₊₁ (8)

which also can be expressed recursively as

y(n)=b y(n−1), n=0 . . . N−1 (9)

wherein y(−1)=a₋₁. Alternatively to the recursion in equation 9 (which generates a subsequent TF tile value based on a preceding TF tile value) it is also possible to perform the recursion in the opposite direction, by e.g. calculating the last TF tile value (at CQMF sample N−1) using equation 8 and then recursively determining temporally earlier TF tile values in the replacement frame 20B′ by multiplying with b⁻¹.

That is, using equation 8 or 9 a set of TF tile values for a replacement frame 20B′ for the second frame may be generated based on a₋₁ and/or b (including Δφ). The most accurate sinusoidal extension is achieved if both a₋₁ and b are known but it is envisaged that either one is sufficient to achieve TF tile value generation.

For example, if only a₋₁ is known a default value for b may be used. An example of a default b value is obtained by setting f₀ to the center frequency of the specific frequency band. For example, for a critically sampled frequency band of 400 Hz bandwidth, a suitable choice of f₀ would be 200 Hz. While this may not correspond to the sinusoidal component of the frequency band this may be a sufficient approximation. On the other hand, if only b is known a default value of a₋₁ may be used. While this may not correspond to the TF tile value of the last CQMF sample of the first frame a retention of the frequency of the sinusoidal component as described by b may be sufficient to form an acceptable replacement frame.

In some implementations, a vector with N elements is determined, each element corresponding to an index n ranging from 0 to N−1 for the replacement frame 20B′. Each of the N elements in vector are proportional (e.g. equal to) to bⁿ whereby the set of TF tile values for the replacement frame 20B′ may be generated by multiplying a TF tile value (e.g. the end parameter a₋₁) of the first frame 20A with the vector.

The phase parameter Δφ can be determined by various methods. Under the assumption that the by-sample phase evolution is approximately constant in the first frame 20A any two subsequent TF tile values in the first frame 20A can be selected and the phase parameter Δφ determined as the difference in phase between the two TF tile values. In practice, the phase of an individual TF tile value x(n) may be determined by taking the arcus tangent of the ratio between the imaginary part of the TF tile value x(n) and the real part of the TF tile value x(n). Since implementations of the arcus tangent function (e.g. a tan 2) returns the phase modulo 2π the phase may be unwrapped to yield the unwrapped phase θ(n).

The phase parameter Δφ may then be determined as the difference between the (unwrapped) phase of two subsequent TF tile values, e.g. Δφ=θ(n+1)−θ(n) for any n=0, 1, . . . N−2.

It is also noted that the by-sample phase difference may be determined from a selection of non-subsequent TF tile values as well. For example, if the difference in phase between a first TF tile value x(n) and a second TF tile value x(n+k) is determined, the by-sample phase difference may be calculated by dividing the difference with k−1 for any k=1, 2, . . . , N−1.

To mitigate the effect of statistical deviations the phase parameter Δφ may be determined as the mean phase difference between TF tile values of two (e.g. consecutive) CQMF samples in a phase context window Wₚ.

The phase context window Wₚ may span a plurality of consecutive CQMF samples of the first frame 20A. For example, the phase context window Wₚ spans all CQMF samples of the first frame 20A or a subset (e.g. a proper or strict subset) of the CQMF samples of the first frame 20A. As another example the phase context window spans CQMF samples of more than one frame, such as at least two first frames which are subsequent to each other but preceding the second frame which is to be replaced with the replacement frame 20B′. In general, the TF tile value generation processes defined herein are not limited to analysis of just the directly preceding first frame, and a plurality of preceding first frames (being valid frames or replacement frames for invalid frames) may be analyzed to reduce statistical fluctuations.

Since the CQMF samples that are closer to the temporal end of first frame 20A (i.e. when n approaches N−1) are temporally closer to the second frame, and may be of greater importance for the generation of TF tile values for the replacement frame 20B′ compared to CQMF samples temporally earlier in the first frame 20A, the phase context window Wₚ may at least contain the last CQMF sample at n=N−1 and the second to last CQMF sample N−2, and optionally the third to last CQMF sample N−3 and optionally further consecutive CQMF samples in an end portion of the first frame 20A.

The mean phase parameter Δφₘₑₐₙ may be calculated by summing the (unwrapped) phase difference between TF tile values of consecutive CQMF samples and dividing by the number of CQMF samples in the phase context window Wₚ. That is, if e.g. the phase context window Wₚ is the entire first valid frame 20A with N CQMF samples the mean phase parameter Δφₘₑₐₙ may be determined as

$$Δ {ϕ}_{m e a n} = \frac{1}{N - 1} \sum θ ( n + 1 ) - θ ( n ) \qquad ( 10 )$$

where n ranges from 0 to N−2.

Additionally, when θ(n) is the unwrapped phase it is realized that the mean phase parameter Δφₘₑₐₙ can be determined (for a phase context window covering the whole valid frame 20A) as

$$Δ {ϕ}_{m e a n} = \frac{1}{N - 1} ( θ ( N - 1 ) - θ ( 0 ) ) . \qquad ( 11 )$$

Of course, equations 10 and 11 can be modified to fit a shorter or longer phase context window Wₚ.

Alternatively to determining the mean phase parameter Δφₘₑₐₙ it is envisaged that a median or mode phase evolution parameter can be determined and used instead of the mean phase parameter Δφₘₑₐₙ.

In some implementations, each TF tile value is available in polar coordinates (i.e. each TF tile value is represented with a magnitude and an unwrapped phase value) or each TF tile value is converted into polar coordinates. That is, each TF tile value may be expressed in the form

x(n)=(ρ(n), θ(n)) (12)
with ρ(n) representing the magnitude of the TF tile value and θ(n) representing the unwrapped phase of the TF tile value. When the TF tile values are represented in polar coordinates the unwrapped phase θ(n) can be extracted from each TF tile value of each CQMF sample directly and used to e.g. determine the mean phase difference parameter Δφₘₑₐₙ according to the above.

Turning to the end parameter φ₋₁ this parameter may according to some implementations be determined directly as the TF tile value of the last CQMF sample (at n=N−1) of the first frame 20A. That is a₋₁=x(N−1). Alternatively, multiple TF tile values in the first frame 20A are analyzed to determine an expected value of x(N−1) which mitigates any statistical deviations wherein the expected value of x(N−1) is used as a₋₁. For example, a linear predictor (as will be described below) may be used to predict a value of x(N−1) based on one or more preceding TF tile values in the first frame 20A. Optionally, the expected value of x(N−1) is identified as the predicted value of x(N−1) using the linear predictor and the observed value of x(N−1) of the first frame 20A.

Hereby, the expected value of x(N−1) may be determined based on the observed value of x(N−1). For example, the expected value of x(N−1) may be determined by a smoothing operation which removes statistical fluctuations (e.g. noise). A smoothing operation may e.g. be a regression based on CQMF sample x(N−1) and one or more preceding CQMF samples.

A useful further improvement of the sinusoidal extension process described above is to consider the case of decaying or increasing magnitudes. Rather than just extending sinusoids of a fixed magnitude analysis of decaying or increasing magnitudes may improve the perceptual quality of replacement frames. It is understood that the magnitude of b from equation 7 above is unity meaning that the magnitude of a₋₁ will be sustained for all CQMF samples of y(n).

By redefining the complex evolution parameter b as

b=κe^{jΔφ} (13)

it is possible to model exponentially decreasing (κ<1) or exponentially increasing (κ>1) sinusoids using the magnitude parameter κ. By determining (or at least approximating) the magnitude parameter κ of the first frame 20A it is possible extend a trend of decaying or increasing magnitude from the first frame 20A into the TF tile values of the replacement frame 20B′ for the second frame 20B.

In some implementations, to determine the magnitude parameter κ, a similar approach may be taken as for the phase parameter Δφ in equations 10 and 11 above, namely determining the mean magnitude ratio between subsequent TF tile values in a magnitude context window Wₘ. The magnitude context window Wₘ may be of the same or different size as the phase context window Wₚ.

As κ is an exponential parameter, it is appropriate to determine the mean value of the by-sample magnitude ratio ϑ_{ρ}(n)=ρ(n+1)/ρ(n) for all CQMF samples that fall inside the magnitude context window Wₘ.

It is also noted that κ can also be calculated as geometric mean (rather than arithmetic mean) across the magnitude context window, which yields

$${κ}_{m e a n} = \sqrt[N - 1]{\frac{ρ ( N - 1 )}{ρ ( 0 )}} . \qquad ( 5 )$$

Similar to the phase parameter Δφ it is understood that the mean magnitude parameter may be replaced with the median or mode magnitude parameter determined in the magnitude context window.

In some implementations, a magnitude parameter κ that exceeds one may be undesired since this leads to an exponential increase in magnitude which may be problematic for the resulting audio quality and/or lead to overloading effects. Hereby, an upper limit of 1 for the magnitude parameter κ may be implemented such that the magnitude parameter κ is equal to or smaller than 1. In practice, this limitation allows the magnitude of the sinusoidal extension into the replacement frame 20B of the second frame 20B to be sustained or decreasing, but not increasing.

The sinusoidal extension process extends sinusoidal signal components of the first frame 20A to generate the TF tile values of a replacement frame 20B′ for the second frame 20B. The frequency spectrum of a purely sinusoidal signal component will be in the form of a single spectral peak located at the frequency f₀ of the sinusoidal signal component. That is, the extended sinusoidal signal component is a single tone of a single frequency which is a very narrowband signal. In theory, a single frequency peak may be described as having zero bandwidth. In some implementations, a narrow band (single frequency) generated signal is desired, especially if the signal represented by the first frame 20A also is narrowband and has a high degree of tonality. The generated TF tile values of the replacement frame 20B′ for the second frame 20B will then be a plausible and accurate extension of the tonal signal in the first frame 20A.

On the other hand, in some implementations, the signal of the first frame 20A has a low degree of tonality and features a non-zero bandwidth. For example, many types of audio signals will feature a spectral maximum at a specific frequency while being surrounded by additional frequency components forming a non-zero bandwidth. To more accurately generate the TF tile values for the replacement frame 20B′ for the second frame 20B for this type of non-tonal signals, the sinusoidal extension process may be modified to implement one or both of a phase perturbation parameter δφ(n) and a magnitude perturbation parameter δκ(n).

The purpose of the phase perturbation parameter δφ(n) and the magnitude perturbation parameter δκ(n) is modify the phase parameter Δφ and magnitude parameter κ determined by the sinusoidal extension process so as to generate a non-zero bandwidth extension y(n) that more closely resembles the non-zero bandwidth of the signal represented by the TF tile values x(n) of the first frame 20A. The phase perturbation parameter δφ(n) and the magnitude perturbation parameter δκ(n) may be described as an additive perturbation noise that may be determined individually for each generated TF tile value or drawn from a random or pseudorandom sequence.

For each generated TF tile value a phase perturbation parameter δφ(n) may be determined and used to perturb the phase parameter Δφ to form a perturbed phase parameter Δφₚ(n) that is used to generate the TF tile values for the replacement frame 20B′ instead of the phase parameter. For example, the phase perturbation parameter δ (n) may define an additive perturbation and the perturbed phase parameter Δφₚ(n) is then calculated as

Δφₚ(n)=Δφ+δφ(n), (6)

for each CQMF sample n=0,1, . . . , N−1.

The phase perturbation parameter δφ(n) may be determined for each CQMF sample n for the replacement frame 20B′ by drawing a random parameter value from a distribution having a predetermined standard deviation σ_{δφ} The predetermined standard deviation σ_{δφ} may be based on the standard deviation of the by-sample phase difference Δθ(n) of the valid frame 20A for the full first frame 20A or in a context window spanning at least a portion of the at least one first frame 20A (that may be equal to or different from the phase context window). For example, the predetermined standard deviation σ_{δφ} may be equal to or proportional to the standard deviation of the by-sample phase difference Δθ(n) for all CQMF samples n of the first frame 20A (or of a context window thereof).

In some implementations, it is undesirable to operate a random number generator for each TF tile value to be generated since this adds computational complexity and may increase the latency. To this end, in some implementations, the phase perturbation parameter δφ(n) for one TF tile value to be generated is obtained as the difference between a by-sample phase difference Δθ(n) and the mean by-sample phase difference Δφₘₑₐₙ from the first frame 20A (or a context window thereof). To obtain another phase perturbation parameter δφ(n) for another TF tile value to be generated the difference between the by-sample phase difference Δθ(n) of another pair of TF tile values and the mean by-sample phase difference Δφₘₑₐₙ in the first frame 20A is calculated. This process is then repeated for multiple pairs of TF tile values in the first frame 20A to generate new phase perturbation parameters δφ(n) for the generation of TF tile values in the replacement frame 20B′ of the second frame that inherently will feature the same standard deviation without operation of a random number generator.

In some implementations, the difference between a by-sample phase difference Δθ(n) and the mean by-sample phase difference Δφₘₑₐₙ from the valid frame 20A (or a context window thereof) is scaled prior to being used for generating the TF tile values of the replacement frame 20B′ for the second frame.

While obtaining the phase perturbation parameter δ (n) as the difference between a by-sample phase difference Δθ(n) and the mean phase difference Δφₘₑₐₙ allows an individual phase perturbation parameter δφ(n) to be determined for each TF tile value to be generated this may not always be necessary. For example, to reduce computational complexity, a set of phase perturbation parameters δθ(n) may be determined for a subset of the TF tile value pairs in the first frame 20A and this set of phase perturbation parameters δθ(n) may then be repeated (e.g. cycled) for the TF tile values to be generated for the replacement frame 20B′ for the second frame.

Similarly, a magnitude perturbation parameter δκ(n) may be determined for each TF tile value to be generated and used to perturb the magnitude parameter κ to form a perturbed phase parameter κₚ(n) that is used generate TF tile values instead of the original magnitude parameter κ. For example, the magnitude perturbation parameter δκ(n) may define an additive perturbation and the perturbed phase parameter κₚ(n) is then obtained as

κₚ(n)=κ+δκ(n). (16)

The magnitude perturbation parameter δκ(n) may be determined for each CQMF sample of the second frame by drawing a random parameter value from a distribution having a predetermined standard deviation σ_{δκ}. The predetermined standard deviation σ_{δκ} may be based on the standard deviation of the by-sample magnitude ratio ϑρ(n) of the first frame 20A or in a context window of the first frame 20A (that may be equal to or different from the magnitude context window Wₘ). For example, the predetermined standard deviation σ_{δκ} may be equal to or proportional to the standard deviation of the by-sample magnitude ratio ϑρ(n) of the first frame 20A (or of a context window thereof).

Alternatively, to avoid utilization of a random number generator, a magnitude perturbation parameter δκ(n) may be determined by calculating a difference between the relative magnitude change of two neighboring CQMF samples in the valid frame 20A and the mean magnitude parameter κₘₑₐₙ. Similarly, additional magnitude perturbation parameters δκ(n) may be determined by calculating the relative magnitude change ϑρ(n) of different pairs and the mean magnitude parameter κₘₑₐₙ. In this case the applied perturbation may be multiplicative according to

κₚ(n)=κδκ(n). (17)

In some implementations, the calculation the of magnitude perturbation parameter δκ(n) is performed in the logarithmic domain and in the logarithmic domain the magnitude perturbation parameters δκ(n) may be determined analogously to the phase perturbation parameters δφ(n) as described above.

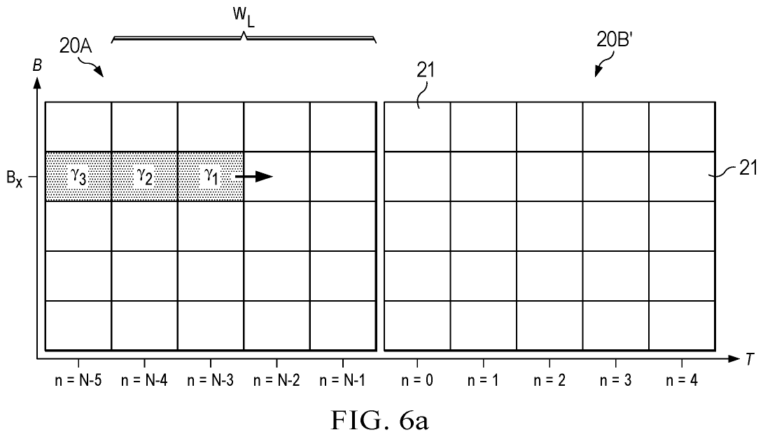

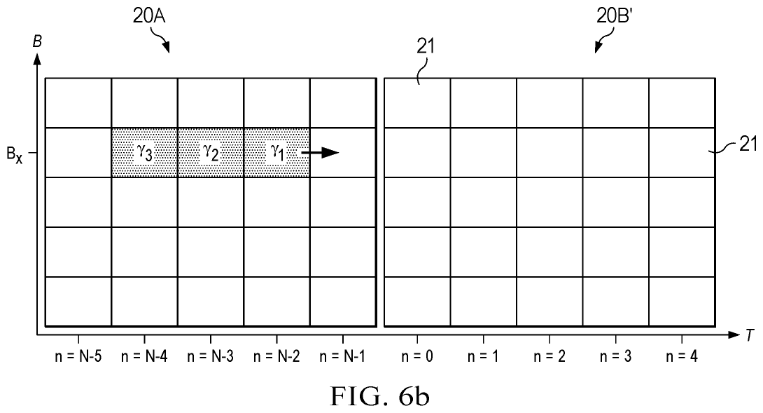

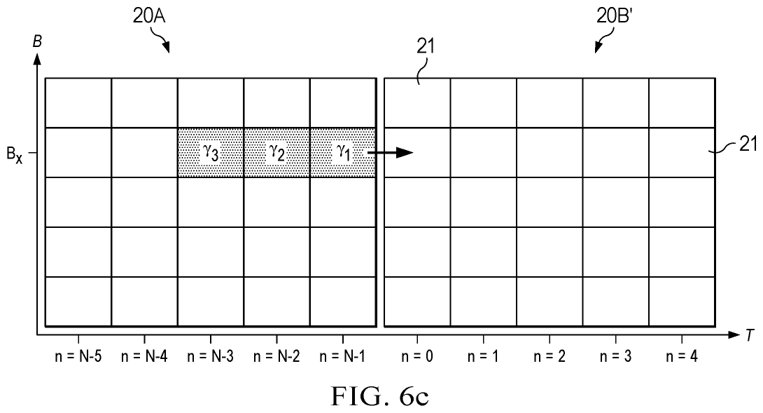

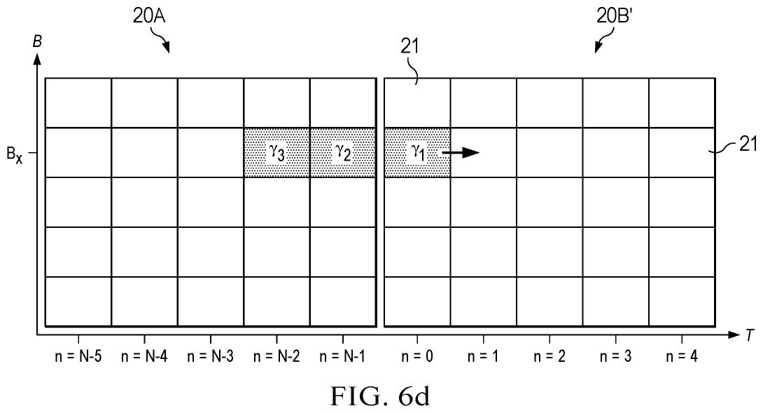

FIGS. 6a-d illustrate schematically the linear predictor process for generating a set of TF tile values for a replacement frame 20B′ of the second frame. The linear predictor process involves defining a linear predictor with complex predictor coefficients γᵢ that recursively generates TF tile values of one or more frequency bands of a replacement frame. The linear predictor process is performed by the frame replacement module to generate TF tile values of one or more frequency bands of a replacement frame.

In FIGS. 6a-d, a preceding first frame 20A (or a generated replacement frame therefore) is used to generate TF tile values of a replacement frame 20B′ for a subsequent invalid frame.

The linear prediction process is a process which is alternative to the sinusoidal extension process. Depending on the degree of tonality of the frequency bands of the first frame 20A, the TF tiles of the replacement frame 20B′ may be generated by the frame replacement module using either the sinusoidal extension process or the sinusoidal extension process.

In the linear prediction process, the TF tile values of a specific frequency band Bₓ of the first frame 20A are analyzed. For example, the TF tile values of at least two CQMF samples of the first frame are analyzed. The TF tile values are analyzed to determine a linear predictor that generates a predicted TF tile value \hat{x}(n) based on one or more preceding TF tile values x(n−i), i>0.

A linear predictor of the first order generates a predicted TF tile value \hat{x}(n) based on one preceding TF tile value, e.g. x(n−1), a linear predictor of the second order generates a predicted TF tile value \hat{x}(n) based on two preceding TF tile values, e.g. x(n−1) and x(n−2), a linear predictor of the third order generates a predicted TF tile value x(n) based on three preceding TF tile values and so on for the fourth and higher order linear predictors.

In some implementations, the linear predictor is of the first, second or third order to keep the computational complexity low. Since the linear predictor according to some implementations operates in a single specific frequency band of limited bandwidth (e.g. around 400 Hz for the CLDFB, or at least less than 1 kHz) the order of the linear predictor can be low, e.g. only of the first or second order.

The linear predictor may be defined so as to minimize a prediction error for all TF tile values in the specific frequency band Bₓ in the first frame 20A (or a context window thereof). For example, the prediction error is the expected value of the mean squared error between a predicted TF tile value \hat{x}(n) and the TF tile value x(n) of the first frame 20A for all TF tile values in the first frame 20A (or in a predictor context window W_{L} of the first frame 20A or in a predictor context window W_{L} spanning multiple frames). For example, the prediction error may be expressed as E[(\hat{x}−x)²].

In some implementations, the linear predictor is defined as

\hat{x}(n)=Σᵢγᵢx(n−i) (18)

wherein index i ranges from 1 to M, M being the order of the predictor and γᵢ are complex valued parameters. This type of linear predictor generates a TF tile value based on at least one preceding, and immediately adjacent TF tile value. As understood from equation 18, the linear predictor comprises as many predictor parameters γᵢ as the predictor order. That is, a first order linear predictor comprises only the parameter γ₁ whereas a second order linear predictor comprise predictor parameters γ₁ and γ₂. As an example, a third order linear predictor generates a TF tile value \hat{x}(n) as

\hat{x}(n)=γ₁x(n−1)+γ₂x(n−2)+γ₃x(n−3) (19)

To determine the complex predictor parameters γᵢ an optimization problem may be formed to fit the complex predictor parameters γᵢ that minimize the prediction error (e.g. E[(\hat{x}−x)²]) for all TF tile values of the specific frequency band of the first frame 20A (or a context window spanning the first frame and optionally earlier frames).

In some implementations, the one or more predictor coefficients γᵢ are calculated according to Levinson-Durbin based on an autocorrelation sequence rₓₓ(n) of the TF tile values of the first frame 20A. For a linear predictor of the first order the single complex predictor coefficient γ1 may then be extracted simply as

$${γ}_{1} = \frac{{r}_{xx} ( 1 )}{{r}_{xx} ( 0 )} . \qquad ( 20 )$$

To generate TF tile values of the second frame 20B the linear predictor is used to predict the tile values of the second frame 20B using, as a starting condition, one or more TF tile values of the first frame 20A. For example, the linear predictor is used to generate the TF tile values y(n) of the invalid frame 20B as

y₍n_{)=Σ}ᵢγᵢy(n−i₎ (21)

wherein the CQMF samples y(j) for negative CQMF sample indexes j are taken from the temporally later end of the preceding first frame 20A, meaning that

y(j)=x(N+j),j<0 (22)

FIGS. 6a and 6b illustrate schematically how a linear predictor of the third order from equation 21 has been defined to generate accurate predictions of the TF tile values in the first frame 20A. In FIG. 6a the third order predictor generates a prediction of the TF tile value in the specific band Bₓ for CQMF sample N−2 using the three complex predictor parameters γ₁, γ₂, γ₃ operating on the TF tile values of preceding CQMF samples N−3, N−4, N−5. Similarly, the third order predictor may generate a prediction of a TF tile value in the specific band By for CQMF sample N−1 using the three complex predictor parameters γ₁, γ₂, γ₃ operating on the TF tile values of preceding CQMF samples N−2, N−3, N−4 as illustrated in FIG. 6b.

However, while FIGS. 6a and 6b illustrate the task the linear predictor has been configured to perform (namely to generate accurate predictions of the TF tile values first frame 20A) the same predictor is used to generate the TF tile values of the specific frequency band Bₓ in the replacement frame 20B′ of the second frame.

FIG. 6c illustrates the predictor from FIGS. 6a and 6b (using the same complex predictor parameters γ₁, γ₂, γ₃) predicting the TF tile value of the first CQMF sample n=0 of the replacement frame 20B′ for the second frame 20B using the last TF tile values of the first frame 20A in CQMF samples N−1, N−2 and N−3 in accordance with equations 21 and 22 above. With the TF tile value of CQMF sample n=0 of the replacement frame 20B′ for the second frame 20B predicted, the linear predictor may then continue and predict the TF tile value in CQMF sample n=1 of the replacement frame 20B′ for the second frame 20B as shown in FIG. 6d using the (already predicted) TF tile value in CQMF sample n=0 of the replacement frame 20B′ and the TF tile values of the preceding first frame 20A in CQMF samples N−1 and N−2. In a similar fashion, the linear predictor may continue to operate through the TF tile values of the replacement frame 20B′ for the second frame 20B to generate all TF tile values of the replacement frame 20B′, in the specific frequency band Bₓ.

For a linear predictor of the first order and of the type operating on immediately preceding CQMF samples according to equation 19 it is noted that the complex predictor parameter γ₁ corresponds to the complex factor b from equation 10. Accordingly, determination of the linear predictor parameter γ₁ (e.g. using equation 20) is another alternative for determining the complex evolution factor b which will incorporate both the magnitude parameter κ and the phase parameter Δφ.

It has been found that the linear predictor of the type from equation 19 tends to predict TF tile values that are decaying. That is, the linear predictor tends to predict complex predictor parameters γ₁ that progressively generates TF tile values with a magnitude that diminishes. The reason for this behavior is that the poles of the inference filter defined by the linear predictor are often inside the unit circle whereas only poles located exactly on the unit circle would allow generating TF tile values of sustained magnitude. A replacement frame 20B′ with decaying TF tile values may result in a decoded time domain audio signal which is perceived as unsteady.

To this end, it is envisaged that for first order predictors the calculated complex predictor parameter γ₁ may be modified by setting its magnitude to one, or at least a predetermined value close to one if |γ₁| is not equal to one, or below the predetermined value close to one. The modified complex predictor parameter γ*₁ thus obtained may then be used by the linear predictor instead of the calculated complex predictor parameter γ₁ when generating TF tile values for a replacement frame for the second frame.

Additionally, it is further noted that for first order predictors the calculated complex predictor parameter γ₁ is a multiplicative value which describes how the TF tile values evolve from one CQMF sample to the next CQMF sample. That is, the complex predictor parameter γ₁ for a first order predictor equals the complex evolution parameter such that b=κe^{jΔφ}=γ₁. Accordingly, if the complex predictor parameter γ₁ is modified such that its magnitude is one, the phase evolution part of the complex evolution parameter b is retained. At the same time, this relationship shows that the complex predictor parameter γ₁ of a first order predictor can be used to determine the phase evolution parameter Δφ (as the phase of the complex predictor parameter γ₁) and/or the magnitude evolution parameter κ (as the magnitude of the complex predictor parameter γ₁). The complex predictor parameter γ₁ therefore introduces another method for determining the phase evolution parameter Δφ and/or the magnitude evolution parameter κ for the sinusoidal extension process by first determining the complex predictor parameter γ₁ and then calculating Δφ and/or κ based on γ₁. The opposite also applies, meaning that γ₁ can be calculated from Δφ (or Δφ and κ).

For higher order predictors (e.g. predictors of the second or third order) it is also possible to counteract a diminishing signal by modifying the predictor parameters from their calculated values. In some implementations, this is achieved by calculating the roots of the predictor polynomial and subsequently identifying modified predictor parameters γ*₂ such that the roots move closer to, or onto the unit circle, while maintaining the phase values of the roots. With such modified predictor parameters the magnitude of generated TF tile values will generally diminish slower, or not at all, which may facilitate improved perceived quality of the replacement frame.

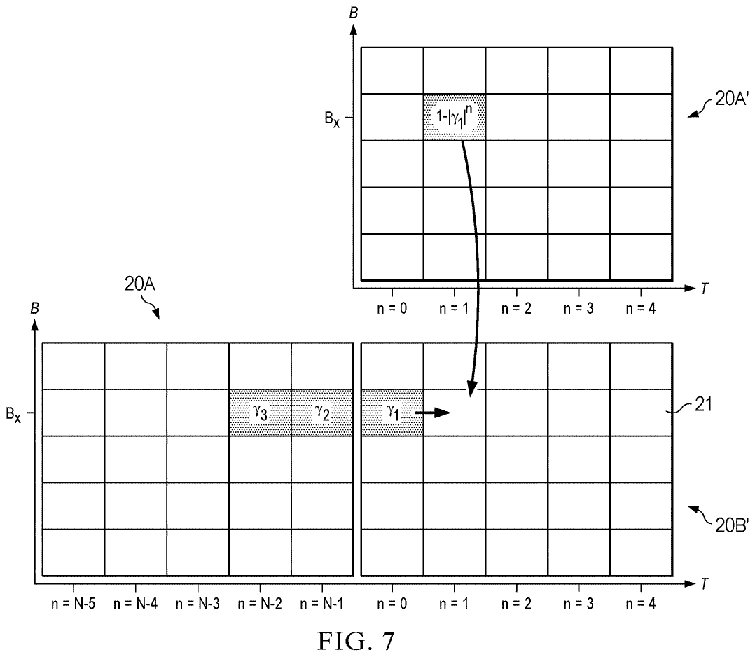

FIG. 7 illustrates a first frame 20A, a generated a replacement frame 20B′ and a substitution frame 20A′.

The TF tile values of the first frame 20A are used to generate TF tile values for the replacement frame 20B′ using the sinusoidal extension process or linear prediction process in each frequency band. Additionally, the TF tile values of the replacement frame 20B′ are further modified by weighted addition of a corresponding TF tile value of the substitution frame 20A′.

In FIG. 7 the TF tile values of frequency band Bₓ in the replacement frame 20B′ are generated using a linear prediction process as described above. The generated TF tile values in the replacement frame 20B′ are further modified as by addition of a corresponding TF tile value in a substitute frame 20A′. For example, the substitute frame 20A′ is a copy of the first frame 20A.

That is, the TF tile values of the replacement frame 20B′ for the second frame 20B may be formed as a weighted sum of generated TF tile values (using sinusoidal extension or linear prediction) and a substitution frame 20A′. In one example, the substitution frame 20A′ is equal to the first frame 20A or a circularly shifted version thereof.

The exponential decay caused by the magnitude parameter κ for sinusoidal extension (which is equal to the magnitude of the first order predictor parameter |γ₁| for a first order predictor) may be compensated by adding the substitution frame 20A′ weighted with a weighing factor 1−κⁿ⁺¹ (or 1−|γ₁|ⁿ⁺¹) such that the generated TF tile values of the replacement frame 20B′ for the second frame 20B are formed as a weighted sum of the TF tile values of the substitution frame 20A′ and the TF tile values generated from the sinusoidal extension process or linear prediction process.

For example, when linear prediction is used each CQMF sample y(n) in the replacement frame 20B′ for the second frame 20B may be generated as

$$y ( n ) = {a}_{- 1} {γ}_{1}^{n + 1} + {y}_{2} ( n ) ( 1 - {\vert {γ}_{1} \vert}^{n + 1} ) \qquad ( 23 )$$

wherein y₂(n) is the corresponding CQMF sample (i.e. of the same frequency band and index n) of the substitution frame 20A′. As mentioned above, a suitable choice for the substitution frame 20A′ is to use the first frame 20A such that

y₂(n)=x(n) (24)

In some implementations, the substitution frame 20A′ is a circularly shifted version of the first frame 20A. For example a circularly shifted version may be obtained as y₂(n)=x(n+i) for all n+i≤N−1 and y₂(n)=x(n+i−N) for all n+i>N−1 where i is an integer.

By reintroducing the substitution frame 20A′ with a weight which compensates for the exponential decay of the generated TF tile values a high quality replacement frame is provided. This forms a crossfade from TF tile values generated with sinusoidal extension process or linear prediction process to the TF tile values of the substitution frame 20A′ which has the perceptual benefit of avoiding signal discontinuities that otherwise would occur if a frame repetition technique was applied without generation of TF tile values with sinusoidal extension or linear prediction.

In accordance with the techniques described above, it is possible to generate the TF tile values of a replacement frame 20B′ for an invalid frame. Now, processes for transitioning back from generated replacement frame 20B′ generated for the second frame 20B to a subsequent valid third frame 20C (which has been received without error) and for generating TF tile values when two or more consecutive frames are invalid will be described.

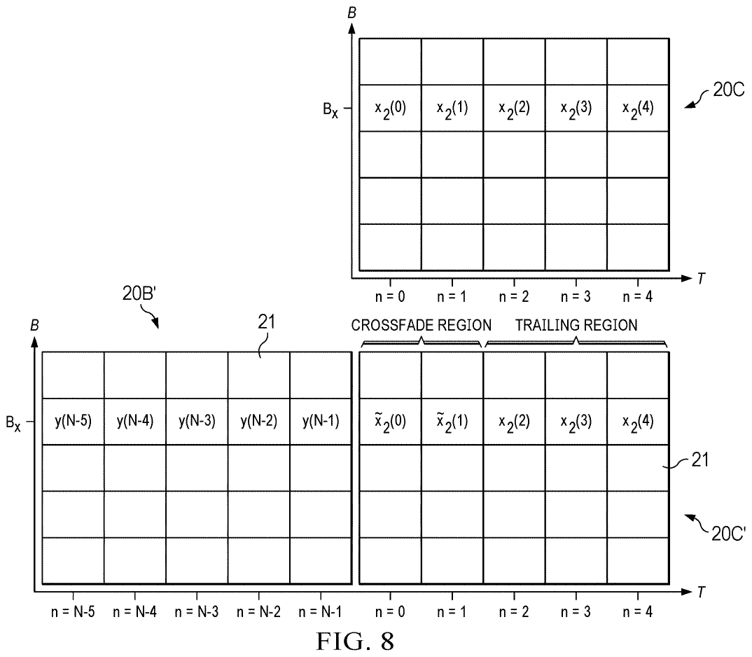

FIG. 8 illustrates a replacement frame 20B′ which has been generated to replace a second frame, a subsequent third valid frame 20C and a replacement frame 20C′ which has been generated to replace the third valid frame 20C.

Generation of a replacement frame may be performed for all invalid frames of a frame sequence. Additionally, generation of replacement frames may also be performed for valid frames during certain circumstances. For example, when a replacement frame 20B′ has been generated to replace a second invalid frame and the subsequent third frame 20C is a valid frame, a replacement frame 20C′ for the third frame 20C may be generated and used as a replacement frame 20C′ for the third frame 20C. The purpose of replacing a valid frame, which follows an invalid frame, with a replacement frame may be to smoothly transition from a replacement frame (which is an approximation of an original frame) into a valid frame.

The TF tile values y(n) of the replacement frame 20B′ have been generated using the sinusoidal extension process and/or the linear prediction process as described above. The third frame 20C is a valid frame that is subsequent to the replacement frame 20B′ for the second frame. To provide a high quality transition from the replacement frame 20B′ to the third frame 20C various techniques may be used to avoid signal discontinuities which would be disruptive for listeners. The CQMF samples of each frequency band Bᵢ of the third frame 20C are labelled x₂(n) for n=0, 1, . . . . N−1.

In some implementations, a crossfading technique is applied to form the replacement frame 20C′ for the third frame to transition from the replacement frame 20B′ of the second frame to TF tile values the third frame 20C. The crossfading technique involves generating extension TF tile values of the replacement frame 20B′ for the second frame that go beyond the N−1 CQMF sample of the replacement frame 20B′ for the second frame and, using these extension CQMF samples that go beyond the N−1 CQMF sample, the replacement frame 20C′ for the third frame 20C is achieved with a crossfading into TF tile values the third frame 20C over a crossfade region. That is, the sinusoidal extension process and/or linear prediction process is used to generate K consecutive extension TF tile values for the replacement frame 20B′ of the second frame with CQMF sample index n≥N. These K extension TF tile values are overlapping in time with the first K TF tile values of the valid third frame 20C.

The number K of extension TF tile values beyond CQMF sample N−1 that are generated may be adjusted based on the desired length of the crossfade region. In one example, the TF tile value of two CQMF samples beyond CQMF sample N−1 are generated, namely the TF tile values of CQMF sample N and N+1. In the CLDFB domain two CLDFB samples correspond to 2.5 ms of audio content.

The K temporally earliest TF tile values of the third frame 20C are labeled k=0, 1, . . . , K−1 and the crossfading may be performed in accordance with

\ddot{x}₂(k)=αₖy(N+k)+βₖx₂(k),k=0 . . . K−1 (25)

wherein \tilde{x}₂(k) is the crossfaded TF tile value for the K temporally earliest CQMF samples in the replacement frame 20C′ for the third frame and αₖ=1−βₖ is a crossfading interpolation parameter. The K temporally earliest TF tile values of the replacement frame 20C′ for the third frame 20C are hereby obtained as a crossfade of generated extension TF tile values y(N+k) that go beyond CQMF sample N−1 of the replacement frame 20B′ of the second frame and the TF tile value x₂(k) of the valid third frame 20C.

The crossfading interpolation parameter αₖ may be adjusted so as to decrease with increasing k. This results in a replacement frame 20C′ with a gradual boosting of the first K TF tile values of the third frame 20C and a matching gradual attenuation of the generated extension TF tile values y(N+k). In one example, the crossfading interpolation parameter αₖ defines linear interpolation and may be set to αₖ=(K−k)/(K+1). It is however understood that other definitions of the crossfading interpolation parameter αₖ are possible, e.g. to define non-linear crossfading profiles.

For TF tile values of the replacement frame 20C′ for the third frame 20C that are temporally later than the first K TF tile values of the crossfade region (i.e. the TF tile values n=K, K+1, . . . , N) the TF tile values are set to that of the third frame 20C. The TF tile values of the third frame 20C that are temporally later than the crossfade region may be referred as the TF tile values of a trailing region which are equal to the corresponding TF tile values of the third frame 20C.

While the crossfading interpolation parameter αₖ may be adjusted over the K extension TF tile values to achieve a desired crossfading profile it is further possible to make use of a decaying linear prediction parameter γ₁ or a sinusoidal extension with a magnitude parameter κ which is smaller than 1. According to this technique, the crossfading duration will not be governed by a predetermined number K of CQMF samples but by the decay rate of the linear prediction parameter γ₁ or the magnitude evolution parameter κ.

In one implementation, the linear predictor process or the sinusoidal extension process is used to generate the extension TF tile values that go beyond CQMF sample N−1 of the second frame 20B whereby these extension TF tile values are crossfaded with the TF tile values of the third frame 20C with a crossfade weighted sum which emphasizes less and less of the extension TF tile values and wherein the crossfade weighting factor corresponds to the decay of the magnitude of the prediction parameter γ₁ or the magnitude parameter κ. For example, for the linear prediction process the K TF tiles of the crossfade region of the replacement frame 20C′ for the third frame 20C are determined as:

$${\tilde{x}}_{2} ( k ) = y ( N - 1 ) {γ}_{1}^{k + 1} + {x}_{2} ( k ) ( 1 - {\vert {γ}_{1} \vert}^{k + 1} ) \qquad ( 26 )$$

for k=0, 1, . . . N−1. Wherein γ₁ is replaced with the magnitude evolution parameter κ if the sinusoidal extension process is used instead of the linear predictor process. The length of the crossfade region will therefore depend on the magnitude of the prediction parameter γ₁ or the magnitude parameter κ wherein a γ₁ or κ which is close to one will result in a long crossfade region and a γ₁ or κ which is closer to zero will result in a shorter crossfade region.

It is envisaged that the replacement frame 20B′ for the third frame 20C is generated according to equation 26 for the K first CQMF samples or until |γ₁|^{k+1} or κ^{k+1} is below a predetermined value, whereafter the TF tile values of the third frame 13 are used without modification.

In some scenarios, there will be two or more frames in a row which are invalid and to generate TF tile values of replacement frames for two or more invalid frames there are two techniques which may be employed: updated extension and continued extension.

In updated extension, a first invalid frame is replaced with a replacement frame in accordance with the above using a preceding valid frame. To generate a replacement frame for a second invalid frame subsequent to the first invalid frame, the replacement frame for the first invalid frame is treated like a valid frame and the processed described above are repeated by generating a replacement frame for the second invalid frame based on the (generated) TF tile values of replacement frame for the first invalid frame.

Notably, the phase evolution parameter Δφ and/or magnitude evolution parameter κ, are calculated based on the replacement frame for the first invalid frame and/or the complex prediction coefficients γᵢ are calculated from the replacement frame for the first invalid frame. This means that for sinusoidal extension, the phase evolution parameter Δφ and/or the magnitude evolution parameter κ used to perform sinusoidal extension to generate the TF tile values of the replacement frame for the second invalid frame may differ from the Δφ and/or K that were used to perform sinusoidal extension to generate the TF tile values for the replacement frame for the first invalid frame. The same applies to any phase or magnitude perturbation parameters which may be updated accordingly. Similarly, for linear prediction the one or more complex prediction coefficients γᵢ used to generate the TF tile values of the replacement frame for the second invalid frame will differ from the one or more complex prediction coefficients γᵢ that were used to generate the TF tile values for the replacement frame for the first invalid frame.

In continued extension, the linear prediction or sinusoidal extension process continues from the replacement frame of the first invalid frame into the replacement frame for the second invalid frame without updating the parameters Δφ, κ and γᵢ. The sinusoidal extension process or the linear prediction process may in principle continue continuously and generate more TF tile values beyond CQMF sample N−1 a frame. Hereby, in continued extension the linear predictor process or sinusoidal extension process continues to generate TF tile values beyond the N CQMF samples constituting the replacement frame for the first invalid frame whereby the next N CQMF samples are used as the replacement frame for the second invalid frame. The process may continue to generate the TF tile values of CQMF samples forming a third, fourth and fifth replacement frame for the corresponding invalid frames as well, with each batch of N TF tile values generated with the sinusoidal extension process or linear prediction process constituting a new replacement frame. Compared to the updated extension, the complex prediction coefficients γᵢ or the phase evolution parameter Δφ and/or the magnitude evolution parameter κ will therefore be retained throughout the generation of TF tile values of all replacement frames. Similarly, the same magnitude and/or phase perturbation parameters may be retained.

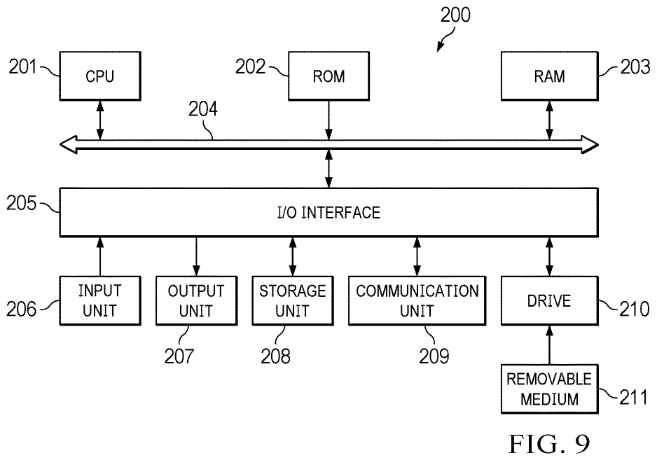

FIG. 9 shows a schematic block diagram of an example electronic device or architecture 200 (e.g., an apparatus 200) suitable for implementing example embodiments of the present disclosure. Architecture 200 includes but is not limited to servers and client devices, systems, modules and methods as described in reference to FIGS. 1a, 1b and 3. As shown, the architecture 200 includes central processing unit (CPU) 201 which is capable of performing various processes in accordance with a program stored in, for example, read only memory (ROM) 202 or a program loaded from, for example, storage unit 208 to random access memory (RAM) 203. The CPU 201 may be, for example, an electronic processor 201, which may include one or more processor cores, and in some examples the processor 201 may be multiple processors. In RAM 203, the data required when CPU 201 performs the various processes is also stored, as required. CPU 201, ROM 202 and RAM 203 are connected to one another via bus 204. Input/output (I/O) interface 205 is also connected to bus 204.

The following components are connected to I/O interface 205: input unit 206, that may include a keyboard, a mouse, or the like; output unit 207 that may include a display such as a liquid crystal display (LCD) and one or more speakers; storage unit 208 including a hard disk, or another suitable storage device; and communication unit 209 which may include a network interface card such as a network card (e.g., wired or wireless).

In some implementations, input unit 206 includes one or more microphones in different positions (depending on the host device) enabling capture of audio signals in various formats (e.g., mono, stereo, spatial, immersive, and other suitable formats).

In some implementations, output unit 207 include systems with various number of speakers. Output unit 207 (depending on the capabilities of the host device) can render audio signals in various formats (e.g., mono, stereo, immersive, binaural, and other suitable formats).

In some embodiments, communication unit 209 is configured to communicate with other devices (e.g., via a network). Drive 210 is also connected to I/O interface 205, as required. Removable medium 211, such as a magnetic disk, an optical disk, a magneto-optical disk, a flash drive or another suitable removable medium is mounted on drive 210, so that a computer program read therefrom is installed into storage unit 208, as required. A person skilled in the art would understand that although apparatus 200 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 209, and/or installed from the removable medium 211, as shown in FIG. 9.

Generally, various example embodiments of the present disclosure may be implemented in hardware or special purpose circuits (e.g., control circuitry), software, logic or any combination thereof. For example, the units discussed above can be executed by control circuitry (e.g., CPU 201 in combination with other components of FIG. 9), thus, the control circuitry may be performing the actions described in this disclosure. Some aspects may be implemented in hardware, while other aspects may be implemented in firmware or software which may be executed by a controller, a processor and/or other computing device(s), which may include control circuitry. While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to one or more processors of a general-purpose computer, special purpose computer, or other programmable data processing apparatus that has control circuitry, such that the program codes, when executed by one or more processors of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

Embodiments described herein perform generation of TF tile values for one or more replacement frames for replacing one or more frames identified as invalid and/or for replacing one or more valid frame when the preceding frame was valid. The methods and processes described may be implemented in an iterative manner wherein the methods and processes are repeated for each frame in a sequence of frames to generate replacement frames, or refrain from generating replacement frames, based on the validity of each frame in the frame sequence.

1. A method to conceal a lost or corrupt frame with audio content in a frame sequence, the method comprising:
obtaining at least one first frame associated with the frame sequence, the at least one first frame being a frame of the frame sequence or a generated replacement frame;
identifying whether a second frame, subsequent to the at least one first frame, is valid or invalid;
when the second frame is identified as invalid, generating a set of Time-Frequency (TF) tile values for a replacement frame to replace the second frame by:
analyzing the at least one first frame to determine a degree of tonality; and
comparing the degree of tonality to a threshold value to determine if the degree of tonality exceeds the threshold value;
when the degree of tonality exceeds the threshold value, applying a sinusoidal extension process to generate the set of TF tile values for the replacement frame; and
when the degree of tonality does not exceed the threshold value, applying a linear prediction process to generate the set of TF tile values for the replacement frame; and
outputting the replacement frame to replace the second frame.

2. The method of claim 1, further comprising:
when the second frame is identified as valid:
identifying whether the at least one first frame is valid or invalid;
when the at least one first frame is identified as invalid, generating a set of TF tile values for a replacement frame to replace the second frame by:
obtaining an extension set of TF tile values of the at least one first frame;
generating one or more crossfaded TF tile values by crossfading the set of TF tile values of the second frame with the extension set of TF tile values of the at least one first frame in a crossfade region; and
outputting the second frame with the one or more crossfaded TF tile values as the replacement frame to replace the second frame.

3. The method of claim 2, wherein obtaining the extension set of TF tile values of the at least one first frame comprises:
generating the extension set of TF tile values based on TF tile values of the at least one first frame based on either the sinusoidal extension process or the linear prediction process.

4. The method of claim 3, wherein each frame comprises N subsequent TF tile values associated with N subsequent samples and wherein the extension set of TF tile values comprises K subsequent TF tile values that span K subsequent samples that are temporally later than the N samples of the first frame.

5. The method of claim 2, wherein the crossfade region comprises a predetermined number of the temporally earliest TF tile values of the set of TF tile values of the second frame.

6. The method of claim 2, wherein generating one or more crossfaded TF tile values comprises, for each TF tile values in the crossfade region, calculating a crossfade weighted sum of a TF tile value of the second frame with a TF tile value of the extension set of TF tile values of the at least one first frame.

7. The method of claim 6, wherein a crossfade weighting factor of the crossfade weighted sum indicates the portion of the crossfade weighted sum that is to be constituted by a TF tile value of the extension set of TF tile values and wherein the weighting factor for subsequent crossfaded TF tile values in the crossfading region decreases for temporally later crossfaded TF tile values.

8. The method of claim 2, wherein the replacement frame comprises the crossfaded TF tile values in the crossfading region and the replacement frame further comprises a trailing region comprising TF tile values of the second frame being outside the crossfading region.

9. The method of claim 2, further comprising:
when the degree of tonality for the at least one first frame exceeds the threshold value, calculating extension TF tile values with sinusoidal extension based on at least two TF tile values of the at least one first frame; and
when the degree of tonality for the first frame does not exceed the threshold value, calculating extension TF tile values with the linear prediction process based on at least two TF tile values of the at least one first frame.

10. A method to conceal a lost or corrupt frame with audio content in a frame sequence, the method comprising:
obtaining at least one first frame associated with the frame sequence, the at least one first frame being a frame of the frame sequence or a generated replacement frame;
identifying whether a second frame, subsequent to the at least one first frame, is valid or invalid;
when the second frame is identified as invalid, generating a set of Time-Frequency (TF) tile values for a replacement frame to replace the second frame by:
analyzing the at least one first frame to determine a degree of tonality; and
comparing the degree of tonality to a threshold value to determine if the degree of tonality exceeds the threshold value;
when the degree of tonality exceeds the threshold value, applying a sinusoidal extension process to generate the set of TF tile values for the replacement frame; and
when the degree of tonality does not exceed the threshold value, applying a linear prediction process to generate the set of TF tile values for the replacement frame; and
outputting the replacement frame to replace the second frame;
wherein the at least one first frame and the second frame are CQMF frames that each include a set of CQMF samples, wherein each of the CQMF samples comprises at least one TF tile value, wherein generating the set of TF tile values for the replacement frame further comprises:
determining a complex parameter based on at least two TF tile values of different CQMF samples in the at least one first frame; and
generating the set of TF tile values for the replacement frame by modifying a TF tile value of the at least one first frame with the complex parameter.

11. The method of claim 10, wherein each CQMF sample is a sample of a Complex Low-Delay Filter Bank, CLDFB, representation as specified in the 3GPP Immersive Voice and Audio Services, IVAS, Codec.

12. The method of claim 10, wherein generating the set of TF tile values for the replacement frame comprises:
generating a first replacement TF tile value in a first CQMF sample of the replacement frame by modifying a TF tile value of the at least one first frame with the complex parameter.

13. The method of claim 12, wherein generating the set of TF tile values for the replacement frame further comprises:
generating a second replacement TF tile value in a second CQMF sample of the replacement frame, subsequent to or preceding the first CQMF sample of the replacement frame, by modifying the generated first replacement TF tile value of the first CQMF sample in the replacement frame with the complex parameter.

14. The method of claim 10, further comprising:
determining a vector, the vector comprising N elements with index n ranging from 0 to N−1, wherein each of the N elements is proportional to the complex parameter to the (n+1)-th power; and
wherein generating the set of TF tile values for the replacement frame comprises:
multiplying a TF tile value of the first frame with the vector.

15. The method of claim 10, wherein the complex parameter includes one or more of a real part, an imaginary part, or both real and imaginary parts.

16. The method of claim 10, wherein applying the sinusoidal extension process to generate the set of TF tile values for the replacement frame further comprises:
calculating the complex parameter as a complex evolution parameter that parameterize a complex sinusoid based on the at least two TF tile values of different CQMF samples in the at least one first frame, and
wherein generating the set of TF tile values for the replacement frame comprises performing sinusoidal extension based on the complex evolution parameter.

17. The method of claim 16, wherein calculating the complex evolution parameter comprises:
calculating a phase parameter of the complex evolution parameter as a mean phase difference between TF tile values of a phase context window of TF tile values of the at least one first frame;
optionally generating the set of TF tile values for the replacement frame with the phase parameter;
optionally calculating at least one phase perturbation parameter based on the deviation of the phase of at least one TF tile value in the first frame from the phase parameter; and
optionally adjusting the phase parameter using the phase perturbation parameter prior to generating the set of TF tile values for the replacement frame with the phase parameter.

18. (canceled)

19. (canceled)

20. The method of claim 16, wherein calculating the complex evolution parameter comprises:
calculating a magnitude parameter of the complex evolution parameter as a mean magnitude ratio between subsequent TF tile values in a magnitude context window of TF tile values of the at least one first frame;
optionally generating the set of TF tile values for the replacement frame with the magnitude parameter;
optionally determining a magnitude perturbation parameter based on the deviation of the magnitude of at least one TF tile value in the at least one first frame from the magnitude parameter; and
optionally adjusting the magnitude parameter using the magnitude perturbation parameter prior to generating the set of TF tile values for the replacement frame with the magnitude parameter.

21-22. (canceled)

23. The method of claim 10, wherein applying the linear prediction extension process to generate the set of TF tile values for the replacement frame further comprises:
calculating the complex parameter as at least one complex predictor coefficient of a linear predictor configured to predict a TF tile value in a subsequent CQMF sample in the at least one first frame based on a TF tile value in at least one preceding CQMF sample of the at least one first frame; and
wherein generating the set of TF tile values for the replacement frame comprises performing linear prediction of the set of TF tile values based on the at least one complex predictor coefficient.

24. The method of claim 23, calculating the complex parameter as at least one complex predictor coefficient comprises:
identifying a first order complex coefficient that is multiplied with a TF tile value of a preceding CQMF sample to predict a TF tile value in a subsequent CQMF sample in a predictor context window of the at least one first frame, wherein the first order complex coefficient is identified by minimizing a prediction error in the predictor context window;
wherein calculating the complex parameter as at least one complex predictor coefficient optionally comprises:
determining a second order complex predictor coefficient that is multiplied with a second preceding TF tile value of a second preceding CQMF sample value to predict the TF tile value in the subsequent COMF sample in the predictor context window, wherein the first and second order predictor coefficients are identified by minimizing the prediction error in the predictor context window.

25. (canceled)

26. The method of claim 23, wherein applying the linear prediction process to generate the set of TF tile values for the replacement frame comprises:
generating a predicted set of TF tile values with the at least one complex predictor coefficient;
forming a set of modified TF tile value as a weighted sum of the predicted set of TF tile values and a set of TF tile values of the at least one first frame; and
forming the replacement frame based on the set of modified TF tile values;
wherein optionally a weighting factor of the weighted sum is based on a magnitude of the at least one complex predictor coefficient;
wherein optionally a first weighting factor for a first modified TF tile value differs from a second weighting factor of a second modified TF tile value such that the ratio between the first and second weighting factors is equal to the magnitude of the at least one complex predictor coefficient; and
wherein optionally the replacement frame comprises the set of modified TF tile values in a decay region and the replacement frame further comprises a repetition region comprising unmodified TF tile values of the first frame, wherein the decay region is temporally earlier than the repetition region.

27-29. (canceled)

30. The method of claim 10, wherein analyzing the at least one first frame to determine the degree of tonality comprises:
evaluating TF tile values of the at least one first frame to identify differences in phase between different TF tile values;
calculating a phase standard deviation based on the identified differences in phase between different TF tile values; and
comparing the phase standard deviation to a phase threshold to determine the at least one first frame is tonal when the phase standard deviation is below the phase threshold, and to determine the at least one first frame is noise-like when the phase standard deviation is equal to or above than the phase threshold.

31-44. (canceled)
